(19) United States
(12) Patent Application Publication
(10) Pub. No.: US 2006/0250593 A1
(43) Pub. Date: Nov. 9, 2006

(54) Exposure apparatus and device fabricating method

(75) Inventor: Yasufumi Nishii, Kumaga-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 11/410,162

(22) Filed: Apr. 25, 2006

(30) Foreign Application Priority Data
Jun. 10, 2004 (JP) 2004-172561

(51) Int. Cl. G03B 27/42

(52) U.S. Cl. 355/53; 355/30

(57) ABSTRACT

The present invention is an exposure apparatus that exposes a substrate through a projection optical system and a liquid, comprising: a first nozzle member, which is provided in the vicinity of the image plane side of the projection optical system, that has a supply port that supplies the liquid and a first recovery port that recovers the liquid; and a second nozzle member, which is provided on the outer side of the first nozzle member with respect to a projection area of the projection optical system, that has a second recovery port, which recovers the liquid, that is separate from the first recovery port. The first nozzle member and the second nozzle member are mutually independent members.

### BACKGROUND OF THE INVENTION

1. Field of the Invention

The present invention relates to an exposure apparatus, which exposes a substrate through a projection optical system and a liquid, and a device fabricating method.

2. Description of Related Art

Semiconductor devices and liquid crystal display devices are fabricated by a so-called photolithography technique, wherein a pattern formed on a mask is transferred onto a photosensitive substrate.

An exposure apparatus used in this photolithographic process comprises a mask stage that supports a mask, as well as a substrate stage that supports a substrate, and transfers the pattern of the mask onto the substrate through a projection optical system while successively moving the mask stage and the substrate stage.

There has been demand in recent years for higher resolution projection optical systems in order to handle the much higher levels of integration of device patterns. The shorter the exposure wavelength used and the larger the numerical aperture of the projection optical system, the higher the resolution of the projection optical system. Consequently, the exposure wavelength used in exposure apparatuses has shortened year by year, and the numerical aperture of projection optical systems has increased. Furthermore, the mainstream exposure wavelength currently is the 248 nm KrF excimer laser, but an even shorter wavelength 193 nm ArF excimer laser is also being commercialized. In addition, as with resolution, the depth of focus (DOF) is important when performing an exposure. The following equations express the resolution R and the depth of focus 6, respectively.
R=k₁·λ/NA, (1)
δ=±k₂·λ/NA², (2)

Therein, λ is the exposure wavelength, NA is the numerical aperture of the projection optical system, and k₁ and k₂ are the process coefficients. Equations (1) and (2) teach that if the exposure wavelength λ is shortened and the numerical aperture NA is increased in order to enhance the resolution R, then the depth of focus δ narrows.

If the depth of focus δ becomes excessively narrow, then it will become difficult to align the front surface of the substrate with the image plane of the projection optical system, and there will be a risk of insufficient margin of focus during the exposure operation. Accordingly, a liquid immersion method has been proposed, as disclosed in, for example, PCT International Publication WO99/49504, as a method to substantially shorten the exposure wavelength and increase the depth of focus. This liquid immersion method forms an immersion area by filling a liquid, such as water or an organic solvent, between the image plane side end surface (lower surface) of the projection optical system and the front surface of the substrate, thus taking advantage of the fact that the wavelength of the exposure light in a liquid is 1/n that of in air (where n is the refractive index of the liquid, normally about 1.2 to 1.6), and thereby improving the resolution as well as increasing the depth of focus by approximately n times.

Incidentally, to satisfactorily perform an immersion exposure process as well as various optical measurement processes through a liquid, it is necessary to satisfactorily perform the operations of supplying and recovering the liquid and to form an immersion area of the liquid in a desired state. For example, if vibrations are generated attendant with the operations of supplying or recovering the liquid and transmitted to the projection optical system, then a problem will arise in that the accuracy of exposures and measurements made through the projection optical system will degrade.

In addition, if a situation arises, such as the formation of an immersion area that is greater than the desired size or the inability to satisfactorily hold the liquid for forming the immersion area between the image plane side end surface of the projection optical system and the front surface of the substrate, then there is an increased possibility that the liquid in the immersion area will flow out to the outer side of the substrate or the substrate stage. If the liquid flows out to the outer side of the substrate or the substrate stage, then there is a possibility that the vaporization of the liquid that flows out will, for example, cause (temperature and humidity) fluctuations in the environment wherein the substrate is placed. In such a case, the thermal fluctuations of the substrate or the substrate stage, or the vaporization of the liquid will cause problems, such as wavering of the gas (air) along the optical paths of the various measurement beams that measure, for example, the positional information of the substrate, as well as degradation of the exposure accuracy, the measurement accuracy, and the like. In addition, if the liquid flows out, then there is also a possibility that it will cause problems, such as electrical leakage as well as rusting of members and equipment in the vicinity of the substrate and the substrate stage.

The present invention considers such circumstances, and it is an object of the present invention to provide an exposure apparatus, which can prevent the degradation of the exposure and measurement accuracies, and a device fabricating method that uses that exposure apparatus.

### SUMMARY OF THE INVENTION

An exposure apparatus of the present invention is an exposure apparatus that exposes a substrate through a projection optical system and a liquid, comprising: a first nozzle member, which is provided in the vicinity of the image plane side of the projection optical system, that at least has either a supply port that supplies the liquid or a first recovery port that recovers the liquid; and a second nozzle member, which is provided on the outer side of the first nozzle member with respect to a projection area of the projection optical system, that has a second recovery port, which recovers the liquid, that is separate from the first recovery port; wherein, the first nozzle member and the second nozzle member are mutually independent members.

According to the present invention, the liquid that was not completely recovered by the first recovery port is recovered via the second recovery port, and it is therefore possible to prevent the outflow of the liquid. Accordingly, it is possible to prevent problems, such as: fluctuations in the environment wherein the substrate is placed due to the outflow of the liquid; as well as, for example, rusting of and electrical leakage in the members and equipment that surround the substrate and the substrate stage. In addition, although there is a possibility that vibrations will be generated when supplying and recovering the liquid, the first nozzle member, which has the supply port and the first recovery port, and the second nozzle member, which has the second recovery port, are mutually independent members, and it is therefore possible to implement optimal antivibration measures for the first and second nozzle members. Accordingly, it is possible to prevent degradation in the exposure and measurement accuracies due to vibrations generated by the nozzle members. In addition, because the first and second nozzle members are mutually independent members, work efficiency can be improved when performing maintenance on these first and second nozzle members, or when replacing them with new ones. For example, when performing maintenance on just the second nozzle member, such maintenance should be performed by removing only the second nozzle member. In so doing, it is possible to quickly implement optimal measures even if a problem arises with the first and second nozzle members. In addition, because the first and second nozzle members are mutually independent members, it is possible to increase the number of degrees of freedom in the design of the nozzle members. Accordingly, the structure of the first and second nozzle members can be simplified, and it is also possible to reduce the manufacturing cost by simplifying the manufacture of those nozzle members.

A device fabricating method of the present invention comprises the step of using an exposure apparatus as described above.

According to the present invention, the immersion area can be satisfactorily formed and high exposure and measurement accuracies can be obtained, and it is therefore possible to manufacture a device that has the desired characteristics.

According to the present invention, the operations of supplying and recovering the liquid can be satisfactorily performed, and it is therefore possible to obtain high exposure and measurement accuracies.

### BRIEF DESCRIPTION OF THE DRAWINGS

FIG. 1 is a schematic block diagram that depicts one embodiment of an exposure apparatus of the present invention.

FIG. 2 is a plan view of first and second nozzle members, viewed from the lower surface side.

FIG. 3 is a cross sectional auxiliary view taken along the A-A line in FIG. 2.

FIG. 4 is a cross sectional auxiliary view taken along the B-B line in FIG. 2.

FIG. 5 is a cross sectional auxiliary view taken along the C-C line in FIG. 2.

FIG. 6A is an oblique view that depicts a state wherein the nozzle members are held by a nozzle holding mechanism.

FIG. 6B is an oblique view that depicts a state wherein the nozzle holding mechanism and the nozzle members are separated.

FIGS. 7A, 7B, 7C, and 7D are schematic drawings that depict one example of the operation of the exposure apparatus of the present invention.

FIGS. 8A and 8B are schematic drawings for the purpose of explaining the positional relationship between a substrate and the first and second nozzle members.

FIG. 9 is a schematic block diagram that depicts another embodiment of the exposure apparatus of the present invention.

FIG. 10 is a cross sectional view that depicts another embodiment of the first nozzle member.

FIG. 11 is a flow chart diagram that depicts one example of a process of manufacturing a semiconductor device.

### DETAILED DESCRIPTION OF THE INVENTION

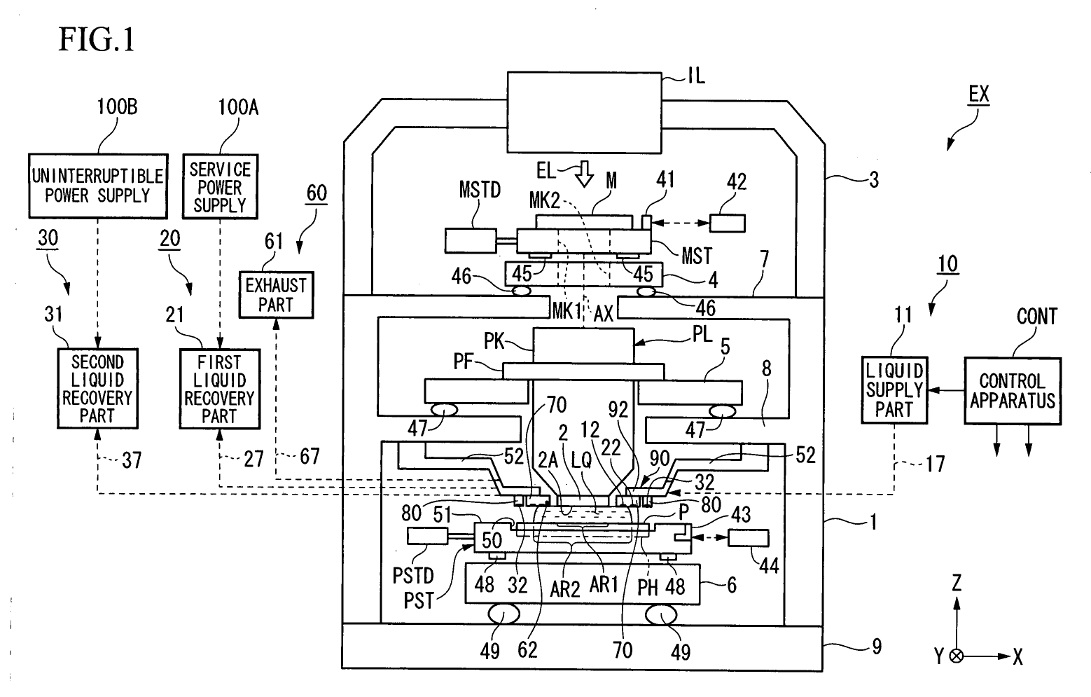

The following explains an exposure apparatus of the present invention, referencing the drawings. However, the present invention is not limited to the embodiments. FIG. 1 is a schematic block diagram that depicts one embodiment of the exposure apparatus of the present invention.

In FIG. 1, an exposure apparatus EX comprises: a mask stage MST that supports a mask M; a substrate stage PST that supports a substrate P; an illumination optical system IL that illuminates the mask M, which is supported by the mask stage MST, with an exposure light EL; a projection optical system PL that projects and exposes a pattern image of the mask M illuminated by the exposure light EL onto the substrate P that is supported by the substrate stage PST; and a control apparatus CONT that provides supervisory control of the operation of the entire exposure apparatus EX. The control apparatus CONT is connected to various measuring means (e.g., interferometers 42, 44 and a focus leveling detection system 120, which are discussed later), drive apparatuses (e.g., a mask stage drive apparatus MSTD and a substrate stage drive apparatus PSTD, which are discussed later), and the like of the exposure apparatus EX, and is constituted so that measurement results and drive instructions can be transmitted thereamong. The entire exposure apparatus EX is constituted so that it is driven by electric power from a service power supply (first drive source) 100A supplied by an electric power company.

The exposure apparatus EX of the present embodiment is a liquid immersion type exposure apparatus that applies the liquid immersion method to substantially shorten the exposure wavelength, improve the resolution, as well as substantially increase the depth of focus. Further, the exposure apparatus EX comprises a liquid supply mechanism 10 that supplies the liquid LQ onto the substrate P, as well as a first liquid recovery mechanism 20 and a second liquid recovery mechanism 30 that recover the liquid LQ on the substrate P. In addition, the exposure apparatus EX comprises an exhaust mechanism 60 that discharges gas on the image plane side of the projection optical system PL. In addition to discharging the gas on the image plane side of the projection optical system PL, the exhaust mechanism 60 discharges bubbles (gas portions) in the liquid LQ in an immersion area AR2. At least during the transfer of the pattern image of the mask M onto the substrate P, the exposure apparatus EX locally forms the immersion area AR2, which is larger than a projection area AR1 and smaller than the substrate P, with the liquid LQ, which is supplied by the liquid supply mechanism 10, on one part of the substrate P that includes the projection area AR1 of the projection optical system PL. Specifically, the exposure apparatus EX uses a local liquid immersion method to fill the liquid LQ between an optical element 2 at the tip part of the projection optical system PL on the image plane side and the front surface of the substrate P disposed on the image plane side thereof. Further, the pattern of the mask M is projected and exposed onto the substrate P by irradiating the substrate P with the exposure light EL that passed through the mask M via the projection optical system PL and the liquid LQ between this projection optical system PL and the substrate P.

In addition, a first nozzle member 70, which is discussed later in detail, is disposed in the vicinity of the image plane side of the projection optical system PL, specifically in the vicinity of the optical element 2 at the end part on the image plane side of the projection optical system PL. The first nozzle member 70 is an annular member that is provided so that it surrounds the optical element 2 above the substrate P (substrate stage PST). The first nozzle member 70 is separably held by a nozzle holding mechanism 90. In addition, a second nozzle member 80, which is separate from the first nozzle member 70, is disposed on the outer side of the first nozzle member 70 with respect to the projection area AR1 of the projection optical system PL. The second nozzle member 80 is an annular member that is provided so that it surrounds the first nozzle member 70 above the substrate P (substrate stage PST). The second nozzle member 80 is also separably held by the nozzle holding mechanism 90. In the present embodiment, the first nozzle member 70 constitutes part of the liquid supply mechanism 10, the first liquid recovery mechanism 20, and the exhaust mechanism 60. The second nozzle member 80 constitutes part of the second liquid recovery mechanism 30.

The present embodiment will now be explained as exemplified by a case of using a scanning type exposure apparatus (a so-called scanning stepper) as the exposure apparatus EX that exposes the substrate P with the pattern formed on the mask M, while synchronously moving the mask M and the substrate P in their respective scanning directions in mutually different orientations (reverse directions). In the following explanation, the direction that coincides with an optical axis AX of the projection optical system PL is the Z axial direction, the direction in which the mask M and the substrate P synchronously move (in the scanning directions) within the plane perpendicular to the Z axial direction is the X axial direction, and the direction (non-scanning direction) perpendicular to the Z axial direction and the X axial direction is the Y axial direction. In addition, the rotational (inclined) directions around the X, Y, and Z axes are the θX, θY, and θZ directions, respectively.

The illumination optical system IL illuminates the mask M, which is supported by the mask stage MST, with the exposure light EL. This illumination optical system IL comprises: an exposure light source; an optical integrator that uniformizes the luminous flux intensity of the light beam emitted from the exposure light source; a condenser lens that condenses the exposure light EL from the optical integrator; a relay lens system; a variable field stop that sets an illumination region on the mask M illuminated by the exposure light EL to be slit shaped; and the like. The illumination optical system IL illuminates the prescribed illumination region on the mask M with the exposure light EL, which has a uniform luminous flux intensity distribution. Examples of light that can be used as the exposure light EL emitted from the illumination optical system IL include: deep ultraviolet light (DUV light), such as the bright lines (g, h, and i lines) in the ultraviolet region emitted from, for example, a mercury lamp, as well as KrF excimer laser light (248 nm wavelength); and vacuum ultraviolet light (VUV light), such as ArF excimer laser light (193 nm wavelength) and F₂ laser light (157 nm wavelength). ArF excimer laser light is used in the present embodiment.

In the present embodiment, pure water is used as the liquid LQ. Pure water is capable of transmitting not only ArF excimer laser light, but also deep ultraviolet light (DUV light), such as the bright lines (g, h, and i lines) in the ultraviolet region emitted from, for example, a mercury lamp, and KrF excimer laser light (248 nm wavelength).

The mask stage MST is capable of holding and moving the mask M and fixes such by, for example, a vacuum chuck (or electrostatic chuck). The mask stage drive apparatus MSTD, which includes a linear motor and the like, can move the mask stage MST in two dimensions within a plane perpendicular to the optical axis AX of the projection optical system PL, i.e., within the XY plane, and can finely rotate the mask stage MST in the θZ direction. Furthermore, the mask stage MST can move in the X axial direction at a specified scanning speed and has a stroke in the X axial direction just long enough so that the entire surface of the mask M can traverse at least the optical axis AX of the projection optical system PL.

A movable mirror 41 is provided on the mask stage MST. In addition, a laser interferometer 42 is provided at a position opposing the movable mirror 41. The laser interferometer 42 measures in real time the position in the two dimensional directions, as well as the rotational angle in the θZ direction (depending on the case, including the rotational angles in the θX and θY directions), of the mask M on the mask stage MST and outputs these measurement results to the control apparatus CONT. The control apparatus CONT controls the position of the mask M, which is supported by the mask stage MST, by driving the mask stage drive apparatus MSTD based on the measurement results of the laser interferometer 42.

The projection optical system PL projects and exposes the pattern of the mask M onto the substrate P at a prescribed projection magnification β, and comprises a plurality of optical elements, which includes the optical element (lens) 2 provided at the tip part of the projection optical system PL on the substrate P side, and these optical elements 2 are supported by a lens barrel PK. In the present embodiment, the projection optical system PL is a reduction system that has a projection magnification β of, for example, ¼, ⅕ or ⅛. Furthermore, the projection optical system PL may be a unity magnification system or an enlargement system.

The optical element 2 at the tip part of the projection optical system PL of the present embodiment juts out from the lens barrel PK, and the liquid LQ of the immersion area AR2 contacts the optical element 2. The optical element 2 is made of fluorite. The liquid LQ can adhere to substantially the entire surface of a liquid contact surface 2A (end surface) of the optical element 2 because the fluorite surface has a strong affinity for water. Namely, because the liquid LQ (water) supplied in the present embodiment has a strong affinity for the liquid contact surface 2A of the optical element 2, the liquid contact surface 2A of the optical element 2 and the liquid LQ have strong adhesion characteristics, and therefore the optical path between the optical element 2 and the substrate P can be reliably filled with the liquid LQ. Furthermore, the optical element 2 may be made of quartz, which also has a strong affinity for water. In addition, the liquid contact surface 2A of the optical element 2 may be given hydrophilic (lyophilic) treatment, such as adhering MgF₂, Al₂O₃, SiO₂, and the like thereto, in order to further raise its affinity for the liquid LQ. Alternatively, because the liquid LQ in the present embodiment is water, which has a high molecular polarity, the liquid contact surface 2A of the optical element 2 can also be lyophilically treated (hydrophilically treated) to impart hydrophilicity by, for example, forming a thin film with a substance that has a molecular structure with a high polarity, such as alcohol. Namely, if using water as the liquid LQ, then it is possible to use a process that provides the liquid contact surface 2A with a thin film that has a molecular structure with a high polarity, such as the OH group.

The substrate stage PST is capable of holding and moving the substrate P via a substrate holder PH, is movable in two dimensions within the XY plane, and is finely rotatable in the θZ direction. Furthermore, the substrate stage PST is also movable in the Z axial direction, the θX direction, and the θY direction. The substrate holder PH holds the substrate P by, for example, a vacuum chuck. The substrate stage drive apparatus PSTD, which is, for example, a linear motor controlled by the control apparatus CONT, drives the substrate stage PST.

A movable mirror 43 is provided on the substrate stage PST. In addition, the laser interferometer 44 is provided at a position opposing the movable mirror 43. The position in the two dimensional directions, as well as the rotational angle of the substrate P on the substrate stage PST, are measured in real time by the laser interferometer 44, and these measurement results are outputted to the control apparatus CONT. The control apparatus CONT positions the substrate P supported by the substrate stage PST by driving the substrate stage drive apparatus PSTD, which includes a linear motor and the like, based on the measurement results of the laser interferometer 44.

A recessed part 50 is provided on the substrate stage PST, and the substrate holder PH that holds the substrate P is disposed in the recessed part 50. Furthermore, an upper surface 51 of the substrate stage PST with the exception of the recessed part 50 is formed as a flat surface (flat part) so that it is at substantially the same height as (flush with) the front surface of the substrate P held by the substrate holder PH. In addition, in the present embodiment, an upper surface of the movable mirror 43 is provided substantially flush with the upper surface 51 of the substrate stage PST. Because the upper surface 51 that is substantially flush with the front surface of the substrate P is provided around the substrate P, it is possible to hold the liquid LQ on the image plane side of the projection optical system PL even when immersion exposing the edge area of the substrate P because there is substantially no step part on the outer side of the edge part of the substrate P, and therefore the immersion area AR2 can be formed satisfactorily. In addition, although there is a gap of approximately 0.1 to 2 mm between the edge part of the substrate P and the flat surface (upper surface) 51 provided around that substrate P, there is virtually no flow of the liquid LQ into that gap due to the surface tension of the liquid LQ, and the liquid LQ can be held below the projection optical system PL by the upper surface 51 even when exposing the vicinity of the circumferential edge of the substrate P.

In addition, by making the upper surface 51 liquid repellent, it is possible to suppress the outflow of the liquid LQ to the outer side of the substrate P (the outer side of the upper surface 51) during the immersion exposure and to smoothly recover the liquid LQ even after the immersion exposure, thereby preventing the problem of the liquid LQ remaining on the upper surface 51. The upper surface 51 of the substrate stage PST can be made liquid repellent by forming such with a liquid repellent material, e.g., polytetrafluoroethylene (Teflon™). Alternatively, the upper surface 51 may also be given a liquid repellency treatment, e.g., coating it with a liquid repellent material such as a fluororesin material like polytetrafluoroethylene, an acrylic resin material, and a silicone based resin material, or affixing a thin film made of one of the abovementioned liquid repellent materials. In addition, the area over which the liquid repellent material is coated (the area that is liquid repellency treated) may be the entire area of the upper surface 51 or may be just a partial area that requires liquid repellency.

Here, the film for the surface treatment, which includes the abovementioned lyophilic treatment and liquid repellency treatment, may be a monolayer film or may be a film made of a plurality of layers. A material that is insoluble in the liquid LQ is used as the lyophilic material for imparting lyophilicity and the liquid repellent material for imparting liquid repellency.

In addition, the exposure apparatus EX comprises a focus leveling detection system (120), which is discussed later, that detects the positional information of the front surface of the substrate P that is supported by the substrate stage PST. The light receiving result of the focus leveling detection system is outputted to the control apparatus CONT. Based on the detection result of the focus leveling detection system, the control apparatus CONT can detect the positional information of the front surface of the substrate P in the Z axial direction, as well as the inclination information of the substrate P in the θX and θY directions. The substrate stage PST aligns the front surface of the substrate P with the image plane of the projection optical system PL using an auto focus system and an auto leveling system by controlling the focus position and the inclination angle of the substrate P, and also positions the substrate P in the X and Y axial directions based on the measurement results of the laser interferometer 44.

The exposure apparatus EX comprises a lens barrel base plate 5, which supports the projection optical system PL, and a main column 1 that supports the lens barrel base plate 5 and the mask stage MST. The main column 1 is installed on a base 9, which is provided on the floor surface. The substrate stage PST is supported on the base 9. An upper side step part 7 and a lower side step part 8, which project inwardly, are formed in the main column 1.

The illumination optical system IL is supported by a support frame 3, which is fixed to an upper part of the main column 1. A mask base plate 4 is supported by the upper side step part 7 of the main column 1 via a vibration isolating apparatus 46. An open part (the sidewalls of which are indicated by the reference symbols MK1 and MK2), through which the pattern image of the mask M passes, is formed at the center part of the mask stage MST and the mask base plate 4. A plurality of air bearings 45, which are noncontact bearings, is provided to a lower surface of the mask stage MST. The mask stage MST is noncontactually supported by the air bearings 45 with respect to the upper surface (guide surface) of the mask base plate 4, and the mask stage drive apparatus MSTD can move the mask stage MST in two dimensions within the XY plane, and can finely rotate such in the θZ direction.

A flange PF is provided at the outer circumference of the lens barrel PK, which holds the projection optical system PL, and the projection optical system PL is supported by the lens barrel base plate 5 via this flange PF. A vibration isolating apparatus 47, which includes an air mount and the like, is disposed between the lens barrel base plate 5 and the lower side step part 8 of the main column 1; in addition, the lens barrel base plate 5, which supports the projection optical system PL, is supported by the lower side step part 8 of the main column 1 via the vibration isolating apparatus 47. This vibration isolating apparatus 47 vibrationally isolates the lens barrel base plate 5 and the main column 1 so that the vibrations of the main column 1 do not transmit to the lens barrel base plate 5, which supports the projection optical system PL.

A plurality of air bearings 48, which are noncontact bearings, is provided to the lower surface of the substrate stage PST. In addition, a substrate base plate 6 is supported on the base 9 via a vibration isolating apparatus 49, which includes an air mount and the like. The substrate stage PST is noncontactually supported by the air bearings 48 with respect to the upper surface (guide surface) of the substrate base plate 6; in addition, the substrate stage drive apparatus PSTD can move the substrate stage PST in two dimensions within the XY plane, and can finely rotate such in the θZ direction. This vibration isolating apparatus 49 vibrationally isolates the substrate base plate 6, the main column 1, and the base 9 (floor surface) so that the vibrations of the base 9 (floor surface), the main column 1, and the like do not transmit to the substrate base plate 6, which noncontactually supports the substrate stage PST.

The first nozzle member 70 and the second nozzle member 80 are each separably held by the nozzle holding mechanism 90. The nozzle holding mechanism 90 holds the first nozzle member 70 and the second nozzle member 80 in a separated state. The nozzle holding mechanism 90 is supported by the lower side step part 8 of the main column 1 via a coupling member 52. The coupling member 52 is fixed to the lower side step part 8 of the main column 1, and the nozzle holding mechanism 90 is fixed to this coupling member 52.

Furthermore, the main column 1, which supports the first nozzle member 70 and the second nozzle member 80 via the nozzle holding mechanism 90 and the coupling member 52, and the lens barrel base plate 5, which supports the lens barrel PK of the projection optical system PL via the flange PF, are vibrationally isolated via the vibration isolating apparatus 47. Accordingly, the transmission of vibrations generated by the first nozzle member 70 and the second nozzle member 80 to the projection optical system PL is prevented. In addition, the main column 1 and the substrate base plate 6, which supports the substrate stage PST, are vibrationally isolated via the vibration isolating apparatus 49. Accordingly, the transmission of vibrations generated by the first nozzle member 70 and the second nozzle member 80 to the substrate stage PST via the main column 1 and the base 9 is prevented. In addition, the main column 1 and the mask base plate 4, which supports the mask stage MST, are vibrationally isolated via the vibration isolating apparatus 46. Accordingly, the transmission of vibrations generated by the first nozzle member 70 and the second nozzle member 80 to the mask stage MST via the main column 1 is prevented.

The liquid supply mechanism 10 supplies the liquid LQ to the image plane side of the projection optical system PL and comprises a liquid supply part 11, which is capable of feeding the liquid LQ, as well as supply pipes 17, each having one end part that is connected to the liquid supply part 11. The liquid supply part 11 comprises a tank that stores the liquid LQ, a temperature regulating apparatus that regulates the temperature of the liquid LQ to be supplied, a filter apparatus that removes foreign matter from the liquid LQ, a pressure pump, and the like. The liquid supply mechanism 10 supplies the liquid LQ onto the substrate P when forming the immersion area AR2 thereon.

The first liquid recovery mechanism 20 recovers the liquid LQ on the image plane side of the projection optical system PL and comprises a first liquid recovery part 21, which is capable of recovering the liquid LQ, as well as a recovery pipe 27, one end part of which is connected to the first liquid recovery part 21. The first liquid recovery part 21 comprises: a vacuum system (a suction apparatus), e.g., a vacuum pump and the like; a gas-liquid separator that separates the recovered liquid LQ and gas; a tank that stores the recovered liquid LQ; and the like. Furthermore, instead of providing the exposure apparatus EX with a vacuum pump, the vacuum system at the plant where the exposure apparatus EX is disposed may be used as the vacuum system. To form the immersion area AR2 on the substrate P, the first liquid recovery mechanism 20 recovers a prescribed amount of the liquid LQ on the substrate P that was supplied by the liquid supply mechanism 10.

The second liquid recovery mechanism 30 recovers the liquid LQ on the image plane side of the projection optical system PL and comprises a second liquid recovery part 31, which is capable of recovering the liquid LQ, as well as a recovery pipe 37, one end part of which is connected to the second liquid recovery part 31. The second liquid recovery part 31 comprises: a vacuum system (a suction apparatus), e.g., a vacuum pump and the like; a gas-liquid separator that separates the recovered liquid LQ and gas; a tank that stores the recovered liquid LQ; and the like. Furthermore, instead of providing the exposure apparatus EX with a vacuum pump, the vacuum system at the plant where the exposure apparatus EX is disposed may be used as the vacuum system.

In addition, the second liquid recovery mechanism 30 has an uninterruptible power supply (second drive source) 100B, which is separate from the service power supply 100A that is the drive source of the entire exposure apparatus EX, which includes the first liquid recovery mechanism 20. The uninterruptible power supply 100B supplies electric power (drive power) to the drive parts of the second liquid recovery mechanism 30 in the event of, for example, a power outage of the service power supply 100A.

The exhaust mechanism 60 exhausts the gas on the image plane side of the projection optical system PL and comprises an exhaust part 61, which is capable of suctioning the gas, and an exhaust pipe 67, one end part of which is connected to the exhaust part 61. The exhaust part 61 comprises: a vacuum system (a suction apparatus), e.g., a vacuum pump and the like; a gas-liquid separator that separates the recovered liquid LQ and gas; a tank that stores the recovered liquid LQ; and the like. Furthermore, instead of providing the exposure apparatus EX with a vacuum pump, the vacuum system at the plant where the exposure apparatus EX is disposed may be used as the vacuum system. Here, because the exhaust part 61 comprises the vacuum system and the gas-liquid separator, it is also possible to recover the liquid LQ on the image plane side of the projection optical system PL.

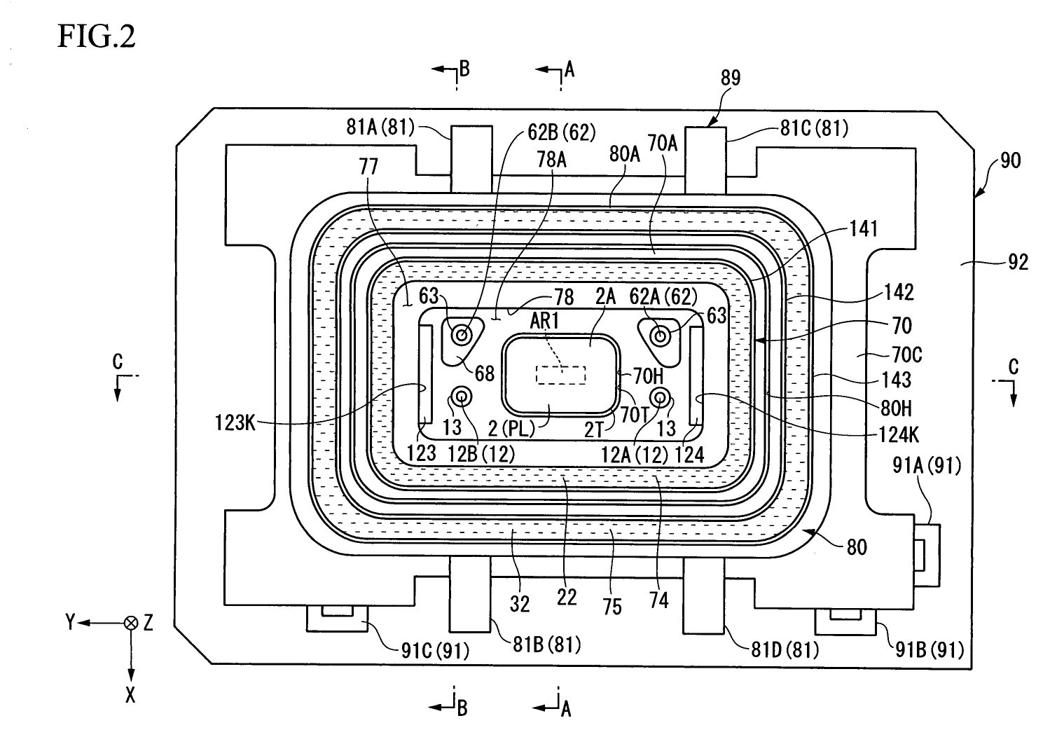

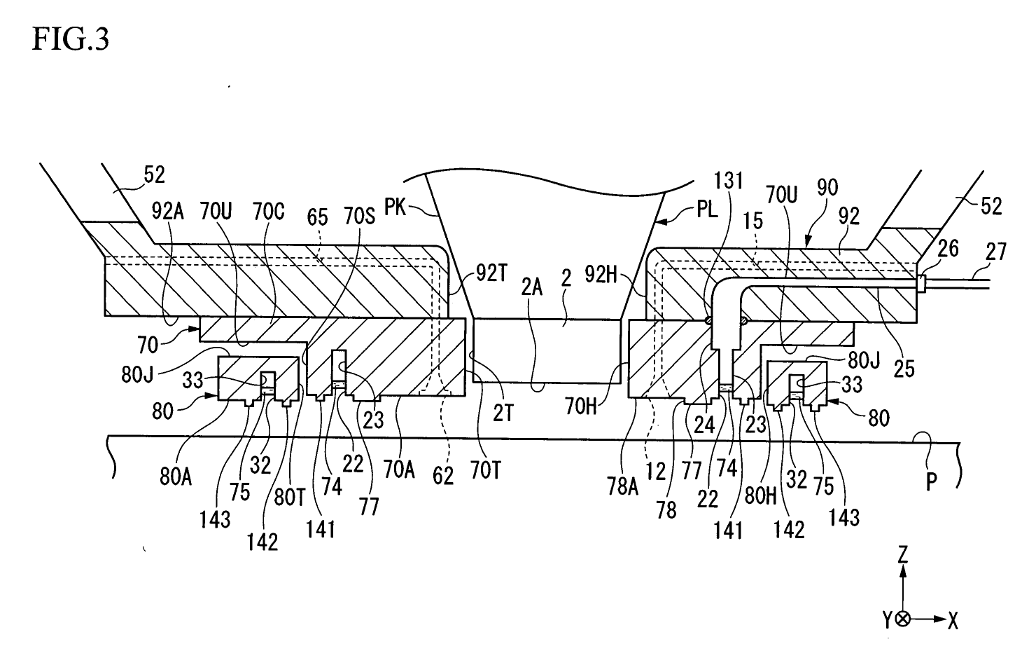

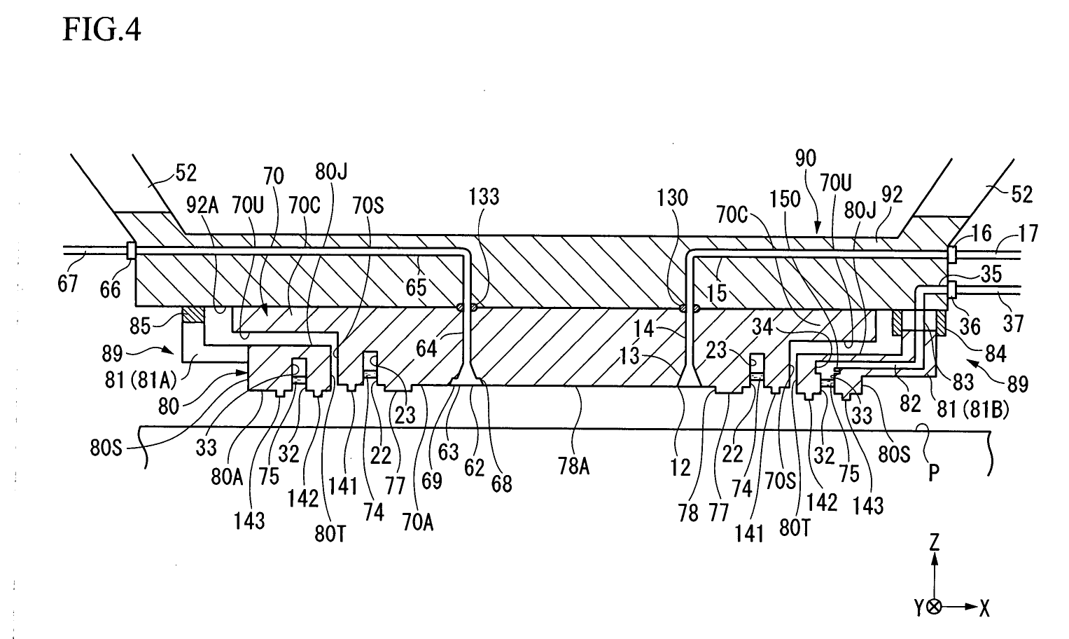

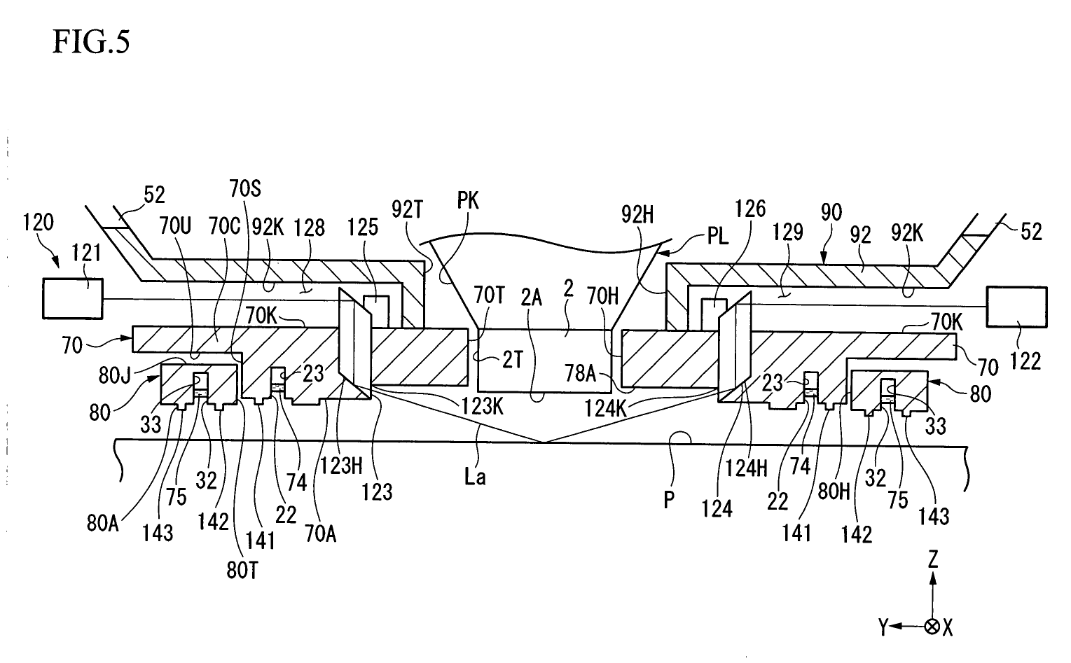

The following explains the first nozzle member 70 and the second nozzle member 80, referencing FIG. 2 through FIG. 5. FIG. 2 is a plan view of the first and second nozzle members 70, 80, viewed from the lower surfaces 70A, 80A; FIG. 3 is a cross sectional auxiliary view taken along the A-A line in FIG. 2; FIG. 4 is a cross sectional auxiliary view taken along the B-B line in FIG. 2; and FIG. 5 is a cross sectional auxiliary view taken along the C-C line in FIG. 2.

The first nozzle member 70 is disposed in the vicinity of the optical element 2, which is at the tip part of the projection optical system PL, and is an annular member that is provided above the substrate P (substrate stage PST) so that it surrounds the circumference of the optical element 2. The first nozzle member 70 constitutes part of the liquid supply mechanism 10, the first liquid recovery mechanism 20, and the exhaust mechanism 60. The first nozzle member 70 has a hole 70H, wherein the projection optical system PL (optical element 2) can be disposed at its center part.

As depicted in FIG. 2, a recessed part 78, the longitudinal direction of which is set to the Y axial direction, is formed in the lower surface 70A, which opposes the substrate P, of the first nozzle member 70. The hole 70H, wherein the projection optical system PL (optical element 2) can be disposed, is formed on the inner side of the recessed part 78. Accordingly, the tip surface 2A, which is disposed in the hole 70H, of the optical element 2 of the projection optical system PL is disposed on the inner side of the recessed part 78. In the present embodiment, the projection area AR1 of the projection optical system PL is set to a rectangular shape, the longitudinal direction of which is set to the Y axial direction (non-scanning direction).

A surface 78A that opposes the substrate P supported by the substrate stage PST and that is substantially parallel to the XY plane is provided on the inner side of the recessed part 78. In the following explanation, the surface 78A that opposes the substrate P and is formed on the inner side of the recessed part 78 is appropriately called a “cavity surface”.

Supply ports 12 (12A, 12B), which constitute part of the liquid supply mechanism 10, are provided to the cavity surface 78A, which is on the inner side of the recessed part 78, of the lower surface 70A of the first nozzle member 70. The supply ports 12 (12A, 12B) are openings wherethrough the liquid LQ flows and are formed in the lower surface 70A (cavity surface 78A). In the present embodiment, two supply ports 12 (12A, 12B), which are disposed on opposite sides of the optical element 2 (projection area AR1) of the projection optical system PL in the Y axial direction, are provided so that the optical element 2 is interposed therebetween. In addition, the supply ports 12A, 12B in the present embodiment are formed in a substantially circular shape. Furthermore, the supply ports 12A, 12B are not limited to a circular shape and may be formed in an arbitrary shape, such as an elliptical or a rectangular shape. In addition, in the present embodiment, the supply ports 12A, 12B are substantially the same size as one another, but may be of mutually differing sizes.

In addition, exhaust ports 62 (62A, 62B), which constitute part of the exhaust mechanism 60, are provided to the cavity surface 78A of the lower surface 70A of the first nozzle member 70. The exhaust ports 62 (62A, 62B) are openings wherethrough the gas or the liquid LQ flow and are formed in the lower surface 70A (cavity surface 78A). In the present embodiment, two exhaust ports 62 (62A, 62B), which are disposed on opposite sides of the optical element 2 (projection area AR1) of the projection optical system PL in the Y axial direction, are provided so that the optical element 2 is interposed therebetween. In addition, the exhaust ports 62A, 62B in the present embodiment are formed in a substantially circular shape. Furthermore, the exhaust ports 62A, 62B are not limited to a circular shape, and may be formed in an arbitrary shape, such as an elliptical or a rectangular shape. In addition, in the present embodiment, the exhaust ports 62A, 62B are substantially the same size as one another, but may be of mutually differing sizes.

In addition, in the present embodiment, the supply port 12A and the exhaust port 62A, as well as the supply port 12B and the exhaust port 62B, are provided in the cavity surface 78A lined up in the X axial direction. In addition, the supply ports 12 and the exhaust ports 62 are each provided in the vicinity of the projection area AR1 of the projection optical system PL. Furthermore, the distance between the projection optical system PL (projection area AR1) and the exhaust ports 62 is provided so that it is substantially equal to or shorter than the distance between the projection optical system PL (projection area AR1) and the supply ports 12.

A first recovery port 22, which constitutes part of the first liquid recovery mechanism 20, is provided to the lower surface 70A of the first nozzle member 70 on the outer side of the recessed part 78, using the projection area AR1 of the projection optical system PL (optical element 2) as a reference.

The first recovery port 22 is an opening wherethrough the liquid LQ flows and is formed in the lower surface 70A of the nozzle member 70. The first recovery port 22 is provided in the lower surface 70A, which opposes the substrate P, of the nozzle member 70 on the outer side of the supply ports 12A, 12B of the liquid supply mechanism 10, as well as on the outer side of the exhaust ports 62A, 62B of the exhaust mechanism 60, with respect to the projection area AR1 of the projection optical system PL. In addition, the first recovery port 22 is annularly formed so that it surrounds the projection area AR1, the supply ports 12A, 12B, and the exhaust ports 62A, 62B. Accordingly, the exhaust ports 62A, 62B are constituted so that they are provided closer to the projection area AR1 of the projection optical system PL than the first recovery port 22. A porous body 74, wherein a plurality of holes is formed, is disposed in the first recovery port 22.

The second nozzle member 80 is an annular member that is provided above the substrate P (substrate stage PST) so that it surrounds the circumference of the first nozzle member 70. The second nozzle member 80 constitutes part of the second liquid recovery mechanism 30. The second nozzle member 80 has a hole 80H, wherein the first nozzle member 70 can be disposed at its center part.

A second recovery port 32, which constitutes part of the second liquid recovery mechanism 30, is provided in the lower surface 80A of the second nozzle member 80. The second recovery port 32 is an opening wherethrough the liquid LQ flows and is formed in the lower surface 80A, which opposes the substrate P, of the second nozzle member 80. The second nozzle member 80 is provided on the outer side of the first nozzle member 70. In addition, the second recovery port 32, which is provided to the second nozzle member 80, is constituted so that it is provided further on the outer side than the first recovery port 22, which is provided to the first nozzle member 70, using the projection area AR1 of the projection optical system PL as a reference. The second recovery port 32 is annularly formed so that it surrounds the first recovery port 22. A porous body 75, wherein a plurality of holes is formed, is also disposed in the second recovery port 32.

The supply ports 12A, 12B are provided between the projection area AR1 of the projection optical system PL and the first recovery port 22. The liquid LQ for forming the immersion area AR2 is supplied from above the substrate P through the supply ports 12A, 12B and to the space between the projection area AR1 of the projection optical system PL and the first recovery port 22. In addition, the first recovery port 22 is formed in an area of the lower surface 70A of the first nozzle member 70 so that it is spaced apart from the outer side of the recessed part 78. A flat area 77, which is substantially flat, is provided between the recessed part 78 and the first recovery port 22. The flat area 77 is substantially parallel to the XY plane and opposes the substrate P, which is supported by the substrate stage PST. In the explanation below, the flat area 77, which is provided around the recessed part 78, is appropriately called a “land surface”.

The first nozzle member 70 and the second nozzle member 80 are each separably held by the nozzle holding mechanism 90. As depicted in FIG. 3 and FIG. 4, the nozzle holding mechanism 90 comprises a nozzle holder 92 that separably holds the first nozzle member 70 and the second nozzle member 80. The nozzle holder 92 has a hole 92H, wherein the projection optical system PL can be disposed at its center part. The first nozzle member 70 is connected to a lower surface 92A of the nozzle holder 92. When the nozzle holding mechanism 90 holds the first nozzle member 70, the hole 92H of the nozzle holder 92 and the hole 70H of the first nozzle member 70 are joined, and the projection optical system PL (optical element 2) is disposed on the inner side of the abovementioned holes 92H and 70H.

The nozzle holding mechanism 90 (nozzle holder 92), which is supported by the lower side step part 8 of the main column 1 via the coupling member 52, and the first nozzle member 70, which is held by that nozzle holding mechanism 90, are spaced apart from the projection optical system PL (optical element 2). Namely, a gap is provided between an inner side surface 70T of the hole 70H of the first nozzle member 70 and a side surface 2T of the optical element 2 of the projection optical system PL; in addition, a gap is also provided between an inner side surface 92T of the hole 92H of the nozzle holder 92 and the lens barrel PK of the projection optical system PL. These gaps are provided in order to vibrationally isolate the projection optical system PL from the first nozzle member 70 and the nozzle holding mechanism 90. Thereby, the transmission of vibrations generated by the first nozzle member 70, the nozzle holding mechanism 90, and the like to the projection optical system PL is prevented. In addition, as discussed above, the main column 1 (lower side step part 8) and the lens barrel base plate 5 are vibrationally isolated via the vibration isolating apparatus 47. Accordingly, the transmission of vibrations generated by the first nozzle member 70, the nozzle holding mechanism 90, and the like to the projection optical system PL via the main column 1 and the lens barrel base plate 5 is prevented.

The first nozzle member 70 and the second nozzle member 80 are mutually independent members, and the nozzle holder 92 of the nozzle holding mechanism 90 holds the first nozzle member 70 and the second nozzle member 80 in a spaced apart state. Here, the first nozzle member 70 has a flange part 70C that is connected to the nozzle holder 92, and the second nozzle member 80 is constituted so that it is disposed below the flange part 70C of the first nozzle member 70. Furthermore, as depicted in FIG. 4, the second nozzle member 80 is connected to the nozzle holding mechanism 90 and the nozzle holder 92 via a connection mechanism 89. A gap is provided between an inner side surface 80T of the second nozzle member 80, which is connected to the nozzle holder 92 via the connection mechanism 89, and an outer side surface 70S of the first nozzle member 70; in addition, a gap is provided between an upper surface 80J of the second nozzle member 80 and a lower surface 70U of the flange part 70C of the first nozzle member 70. These gaps are provided in order to vibrationally isolate the first nozzle member 70 and the second nozzle member 80. The transmission of vibrations generated by the second nozzle member 80 to the first nozzle member 70 is thereby prevented.

The connection mechanism 89 comprises a connecting member 81 and elastic bodies 84, 85. The elastic bodies 84, 85 connect one end part of the connecting member 81 and the lower surface 92A of the nozzle holder 92 of the nozzle holding mechanism 90, and the other end part of the connecting member 81 is connected to an outer side surface 80S of the second nozzle member 80. In the present embodiment, the elastic bodies 84, 85 are made of rubber or a bellows member and the like. As depicted in FIG. 2, the connecting member 81 in the present embodiment comprises four members-first to fourth connecting members 81A to 81D. The connection mechanism 89, which has the elastic bodies 84, 85, flexibly connects the second nozzle member 80 to the nozzle holder 92 of the nozzle holding mechanism 90. In addition, the second nozzle member 80 is capable of oscillating with respect to the nozzle holder 92 via the elastic bodies 84, 85. Namely, the connection mechanism 89, which has the elastic bodies 84, 85, movably connects the second nozzle member 80 to the nozzle holder 92 of the nozzle holding mechanism 90.

In addition, the elastic bodies 84, 85 function as a vibration isolating mechanism, and the connection mechanism 89, which has those elastic bodies 84, 85, vibrationally isolates the second nozzle member 80 and the nozzle holder 92. Accordingly, the connection mechanism 89 can attenuate the vibrations generated by the second nozzle member 80 so that they are not transmitted to the nozzle holder 92 of the nozzle holding mechanism 90. In addition, as discussed above, the main column 1 (lower side step part 8), which supports the nozzle holding mechanism 90 via the coupling member 52, and the lens barrel base plate 5 are vibrationally isolated via the vibration isolating apparatus 47. Accordingly, the transmission of vibrations generated by the second nozzle member 80, the nozzle holding mechanism 90, and the like to the projection optical system PL via the main column 1 and the lens barrel base plate 5 is prevented. Thus, by providing both the vibration isolating apparatus 47 and the elastic bodies 84, 85, it is possible to reliably prevent the transmission of vibrations generated by the second nozzle member 80 to the projection optical system PL.

The elastic bodies 84, 85 of the connection mechanism 89 function as a passive type vibration isolating mechanism, and can attenuate particularly the high frequency components of the vibrations generated by the second nozzle member 80. As is discussed later, there is a possibility that the second nozzle member 80 will generate high frequency components of vibrations when the liquid LQ is collected because the liquid LQ and the surrounding gas are collected together. With the present embodiment, it is possible to effectively attenuate such high frequency components of vibrations via the elastic bodies 84, 85. In addition, it is possible to attenuate low frequency components of vibration by configuring an active type vibration isolating mechanism by, for example, providing an actuator and the like to the vibration isolating apparatus 47, and then controlling this actuator. Furthermore, an actuator and the like may be added to the connection mechanism 89 and serve as an active type vibration isolating mechanism. In addition, in place of the elastic bodies 84, 85 or in parallel therewith, the second nozzle member 80 may be connected to the nozzle holder 92 by the magnetic force of a magnet and the like. For example, it is possible to noncontactually connect the second nozzle member 80 to the nozzle holder 92 by disposing a plurality of magnets therebetween and balancing the attraction and repellent forces between each of the mutually opposing magnets.

As depicted in FIG. 3 and FIG. 4, a supply passageway 15, a first recovery passageway 25, a second recovery passageway 35, and an exhaust passageway 65 are formed inside the nozzle holder 92. The supply passageway 15 constitutes part of the liquid supply mechanism 10, the first recovery passageway 25 constitutes part of the first liquid recovery mechanism 20, the second recovery passageway 35 constitutes part of the second liquid recovery mechanism 30, and the exhaust passageway 65 constitutes part of the exhaust mechanism 60. Accordingly, the nozzle holding mechanism 90 (nozzle holder 92) constitutes part of the liquid supply mechanism 10, the first liquid recovery mechanism 20, the second liquid recovery mechanism 30, and the exhaust mechanism 60.

One end part of the supply passageway 15 formed inside the nozzle holder 92 is connected to the other end part of the supply pipe 17 via a joint 16. In addition, the other end part of the supply passageway 15 is connected to one end part of a supply passageway 14 formed inside the first nozzle member 70. One end part of the supply passageway 15 of the nozzle holder 92 is provided to a side surface of the nozzle holder 92. In addition, the other end part is provided to the lower surface 92A of the nozzle holder 92. In addition, one end part of the supply passageway 14 of the first nozzle member 70 is provided to the upper surface of the first nozzle member 70. Meanwhile, the other end part of the supply passageway 14 is connected to the one of the supply ports 12 formed in the lower surface 70A (cavity surface 78A) of the first nozzle member 70. Here, the supply passageway 14 formed inside the first nozzle member 70 branches midway so that it can connect the other end part thereof to the plurality (two) of supply ports 12 (12A, 12B).

Furthermore, by holding the first nozzle member 70 via the nozzle holder 92, one end part of the supply passageway 14 of the first nozzle member 70 and the other end part of the supply passageway 15 of the nozzle holder 92 are connected. Here, one end part of the supply passageway 15 formed inside the nozzle holder 92 is connected to the liquid supply part 11, which is capable of supplying the liquid LQ, via the supply pipe 17. In addition, the other end part of the supply passageway 15 is connected to the supply ports 12, which are capable of supplying the liquid LQ to the image plane side of the projection optical system PL, via the supply passageway 14 formed inside the first nozzle member 70. Accordingly, the supply passageway 15 of the nozzle holder 92 is constituted so that it connects the liquid supply part 11 and the first nozzle member 70.

In addition, as depicted in FIG. 4, a sealing member 130, which inhibits the leakage of the liquid LQ, is provided to a connection part between the supply passageway 15 of the nozzle holder 92 and the supply passageway 14 of the first nozzle member 70. In the present embodiment, the sealing member 130 comprises an O ring. Furthermore, the sealing member 130 is not limited to an O ring and an arbitrary sealing member, such as sealing tape, can be used as long as it can inhibit the leakage of the liquid LQ. Providing the sealing member 130 inhibits the leakage of the liquid LQ, which flows through the supply passageways 14, 15, from the connection part.

The control apparatus CONT controls the operation of supplying the liquid LQ by the liquid supply part 11. To form the immersion area AR2, the control apparatus CONT feeds the liquid LQ by the liquid supply part 11 of the liquid supply mechanism 10. The liquid LQ fed by the liquid supply part 11 flows through the supply pipe 17 and then flows into the supply passageway 15, which is an internal passageway of the nozzle holder 92. The liquid LQ that flows through the supply passageway 15 of the nozzle holder 92 flows into one end part of the supply passageway 14, which is formed inside the first nozzle member 70. Furthermore, the liquid LQ that flows into one end part of the supply passageway 14 branches midway, and is then supplied by the plurality (two) of supply ports 12A, 12B, which are formed in the lower surface 70A (cavity surface 78A) of the first nozzle member 70, onto the substrate P disposed on the image plane side of the projection optical system PL. The liquid supply mechanism 10 is capable of supplying the liquid LQ from the supply ports 12A, 12B simultaneously.

In the present embodiment, the supply passageway 14 formed in the first nozzle member 70 is formed along the vertical direction (Z axial direction) in the vicinity of the supply ports 12, and the supply ports 12 are provided (downwardly oriented) to the lower surface 70A of the nozzle member 70 so that they face the −Z direction. The liquid supply mechanism 10 supplies the liquid LQ from above onto the front surface of the substrate P in the vertically downward (−Z direction) via the supply ports 12.

As depicted in FIG. 4, the supply passageway 14, which is connected to the supply ports 12, forms an inclined surface 13 in the vicinity of one of the supply ports 12 that gradually widens toward it. The force of the liquid LQ, which is supplied onto the substrate P (substrate stage PST), against the substrate P is distributed because the supply passageway 14, which is formed inside the first nozzle member 70 and is connected to the supply ports 12, is formed so that it gradually widens toward the supply ports (outlets) 12 in the vicinity thereof. Accordingly, it is possible to suppress the force exerted by the supplied liquid LQ on the substrate P, the substrate stage PST, and the like. Accordingly, it is possible to prevent problems, such as the deformation of the substrate P, the substrate stage PST, and the like by the supplied liquid LQ, and it is thereby possible to obtain high exposure and measurement accuracies.

Furthermore, in the present embodiment, the flared supply ports 12 supply the liquid LQ from above the substrate P in a vertically downward direction, but the liquid LQ may be supplied from a direction diagonal to the front surface (XY plane) of the substrate P. Namely, the supply ports 12 may be formed so that they are inclined with respect to the XY plane.

In addition, a flow controller called a mass flow controller can be provided at a prescribed position of a supply passageway of the liquid LQ, such as midway in the supply pipe 17. This mass flow controller controls the amount of liquid LQ that is fed from the liquid supply part 11 and supplied per unit of time to the supply ports 12A, 12B. The control apparatus CONT can control, via the flow controller, the amount of liquid LQ supplied via the supply ports 12A, 12B. In addition, a valve that opens and closes a supply passageway can be provided at a prescribed position of the supply passageway of the liquid LQ, such as midway in the supply pipe 17. The control apparatus CONT uses the abovementioned valve to close the supply passageway at a prescribed timing, and it is therefore possible to stop the supply of liquid LQ via the supply ports 12A, 12B.

One end part of the first recovery passageway 25, which is formed inside the nozzle holder 92, is connected to the other end part of the recovery pipe 27 via a joint 26. In addition, the other end part of the first recovery passageway 25 is connected to one end part of a manifold passageway 24, which is a first recovery passageway formed inside the first nozzle member 70. Here, one end part of the first recovery passageway 25 of the nozzle holder 92 is provided to a side surface of the nozzle holder 92, and the other end part is provided to the lower surface 92A of the nozzle holder 92. In addition, one end part of the manifold passageway 24 of the nozzle member 70 is provided to the upper surface of the first nozzle member 70. Meanwhile, the other end part of the manifold passageway 24 is annularly formed in a plan view so that it corresponds to the first recovery port 22, and is connected to one part of an annular passageway 23, which is connected to that first recovery port 22.

Furthermore, by holding the first nozzle member 70 via the nozzle holder 92, one end part of the manifold passageway (first recovery passageway) 24 of the first nozzle member 70 and the other end part of the first recovery passageway 25 of the nozzle holder 92 are connected. Here, one end part of the first recovery passageway 25 formed inside the nozzle holder 92 is connected to the first liquid recovery part 21, which is capable of recovering the liquid LQ, via the recovery pipe 27, and the other end part of the first recovery passageway 25 is connected to the first recovery port 22, which is capable of recovering the liquid LQ on the image plane side of the projection optical system PL, via the annular passageway 23 and the manifold passageway 24, which is the first recovery passageway formed inside the first nozzle member 70. Accordingly, the first recovery passageway 25 of the nozzle holder 92 is constituted so that it connects the first liquid recovery part 21 and the first nozzle member 70.

In addition, as depicted in FIG. 3, a sealing member 131 that inhibits leakage of the liquid LQ is provided to a connection part between the first recovery passageway 25 of the nozzle holder 92 and the manifold passageway 24 of the first nozzle member 70.

The sealing member 131 can comprise an O ring and the like, the same as the sealing member 130. Providing the sealing member 131 prevents leakage of the liquid LQ, which flows through the first recovery passageways 24, 25, from the abovementioned connection part. The control apparatus CONT controls the operation of recovering the liquid LQ via the first liquid recovery part 21. To recover the liquid LQ, the control apparatus CONT drives the first liquid recovery part 21 of the first liquid recovery mechanism 20.

By driving the first liquid recovery part 21, which has a vacuum system, the liquid LQ on the substrate P flows in the vertically upward (+Z direction) into the annular passageway 23 via the first recovery port 22 provided above the substrate P. The liquid LQ that flows in the +Z direction into the annular passageway 23 gathers at the manifold passageway 24 and then flows therethrough. Subsequently, the liquid LQ flows through the first recovery passageway 25 of the nozzle holder 92 and is then suctioned and recovered by the first liquid recovery part 21 through the recovery pipe 27.

One end part of the second recovery passageway 35 formed inside the nozzle holder 92 is connected to the other end part of the recovery pipe 37 via a joint 36. In addition, the other end part of the second recovery passageway 35 is connected via a connecting pipe 83 to one end part of an interior passageway 82 formed inside, among the first to fourth connecting members 81A to 81D, the second connecting member 81B. The connecting pipe 83 constitutes one part of the connection mechanism 89. One end part of the second recovery passageway 35 of the nozzle holder 92 is provided to a side surface thereof, and the other end part is provided to the lower surface 92A of the nozzle holder 92. Here, one end part of the second connecting member 81B and the lower surface 92A of the nozzle holder 92 are spaced apart, and the connecting pipe 83 connects the other end part of the second recovery passageway 35 provided to the lower surface 92A of the nozzle holder 92 and one end part of the interior passageway 82 provided to one end part of the second connecting member 81B. The elastic body 84 provided between the second connecting member 81B and the nozzle holder 92 is annularly formed, and the connecting pipe 83 is disposed on the inner side of the annularly formed elastic body 84. Here, the connecting pipe 83 comprises a flexible member. Accordingly, the elastic deformation of the elastic body 84 and the relative motion of the nozzle holder 92 and the second nozzle member 80 do not interfere. Furthermore, there is no internal passageway in the connecting members 81A-81D, with the exception of the second connecting member 81B. Accordingly, although the elastic body 85, which connects these connecting members 81A, 81C, 81D and the lower surface 92A of the nozzle holder 92, does not need to be annularly shaped, it of course may be annularly shaped.

The other end part of the interior passageway 82 formed in the second connecting member 81B is connected to one end part of a manifold passageway 34, which is a second recovery passageway formed inside the second nozzle member 80. Meanwhile, the other end part of the manifold passageway 34 is annularly formed in a plan view so that it corresponds to the second recovery port 32, and is connected to part of an annular passageway 33, which is connected to that second recovery port 32.

Furthermore, by connecting the second nozzle member 80 to the nozzle holder 92 via the connection mechanism 89, one end part of the manifold passageway (second recovery passageway) 34 of the second nozzle member 80 and the other end part of the second recovery passageway 35 of the nozzle holder 92 are connected via the connecting pipe 83, which constitutes the connection mechanism 89, and the interior passageway 82 of the second connecting member 81B. Here, the one end part of the second recovery passageway 35 formed inside the nozzle holder 92 is connected to the second liquid recovery part 31, which is capable of recovering the liquid LQ, via the recovery pipe 37. In addition, the other end part of the second recovery passageway 35 is connected to the second recovery port 32, which is capable of recovering the liquid LQ on the image plane side of the projection optical system PL, via the connecting pipe 83, the interior passageway 82, the manifold passageway 34, which is the second recovery passageway formed inside the second nozzle member 80, and the annular passageway 33. Accordingly, the second recovery passageway 35 of the nozzle holder 92 is constituted so that it connects the second liquid recovery part 31 and the second nozzle member 80.

Furthermore, a sealing member that inhibits the leakage of the liquid LQ can be provided to the connection part between the connecting pipe 83 and the second recovery passageway 35 of the nozzle holder 92, as well as to the connection part between the connecting pipe 83 and the interior passageway 82 of the second connecting member 81B. The sealing member can comprise an O ring and the like, the same as the abovementioned sealing members 130, 131.

As depicted in FIG. 4, a detector 150, which comprises a liquid presence sensor that detects whether the liquid LQ was recovered via the second recovery port 32, is provided to the manifold passageway 34, which is connected to the second recovery port 32. The detection result of the detector 150 is output to the control apparatus CONT. The control apparatus CONT controls the operation of the exposure apparatus EX based on the detection result of the detector 150.

The detector 150 should be installed at a position at which it is possible to detect whether the liquid LQ has been recovered via the second recovery port 32, such as in the vicinity of the second recovery port 32, or inside the interior passageway 82, the connecting pipe 83, the recovery pipe 37, and the like. In addition, a transmissive window may be provided to, for example, part of the recovery pipe 37, a detection beam may be irradiated from the outer side of the recovery pipe 37 through this transmissive window, and a detector may be provided that optically detects whether the liquid LQ is flowing to the recovery pipe 37. The control apparatus CONT can determine, based on the detection result of the detector, whether the liquid LQ was recovered via the second recovery port 32. In addition, a mass flow controller and the like may be provided in advance as the detector along, for example, the recovery pipe 37, and a determination of whether the liquid LQ was recovered via the second recovery port 32 may be made based on the detection result of that mass flow controller.

The control apparatus CONT controls the operation of the recovery of the liquid LQ by the second liquid recovery part 31. To recover the liquid LQ, the control apparatus CONT drives the second liquid recovery part 31 of the second liquid recovery mechanism 30. By driving the second liquid recovery part 31, which has a vacuum system, the liquid LQ flows in the vertically upward direction (+Z direction) into the annular passageway 33 via the second recovery port 32 provided above the substrate P. The liquid LQ that flows in the +Z direction into the annular passageway 33 gathers at the manifold passageway 34 and then flows therethrough. Subsequently, the liquid LQ sequentially flows through the interior passageway 82 of the second connecting member 81B, the connecting pipe 83, and the second recovery passageway 35 of the nozzle holder 92, and is then suctioned and recovered by the second liquid recovery part 31 via the second recovery pipe 37.

Here, the second liquid recovery mechanism 30 is continuously driven by the uninterruptible power supply 100B. Furthermore, the first liquid recovery mechanism 20 and the second liquid recovery mechanism 30 are constituted so that they are each driven by separate power supplies 100A, 100B. For example, if a power outage occurs at the service power supply 100A, then the second liquid recovery part 31 of the second liquid recovery mechanism 30 is driven by the electric power supplied from the uninterruptible power supply 10B. In this case, the operation of recovering the liquid LQ by the second liquid recovery mechanism 30, which includes the second liquid recovery part 31, is not controlled by the control apparatus CONT, but rather by a command signal from a separate control apparatus built into, for example, the second liquid recovery mechanism 30. Alternatively, if there is a power outage at the service power supply 100A, then the uninterruptible power supply 100B may supply electric power to the control apparatus CONT in addition to the second liquid recovery mechanism 30. In this case, the control apparatus CONT, which is driven by the electric power from that uninterruptible power supply 100B, may control the operation of recovering the liquid LQ by the second liquid recovery mechanism 30.

Furthermore, in the present embodiment, the first recovery port 22 is annularly formed, and the present embodiment is constituted so that it provides one each of the recovery passageways 23, 24, 25, the recovery pipe 27, and the first liquid recovery part 21, which are connected to that first recovery port 22; however, the present invention is not limited thereto. For example, the first recovery port 22 may be divided into a plurality of first recovery ports 22, and recovery passageways, recovery pipes, or first liquid recovery parts 21 may be provided corresponding in number to the plurality of first recovery ports 22. Furthermore, even if the first recovery port 22 is divided into a plurality, it is preferable that the plurality of first recovery ports 22 is disposed so that it surrounds the projection area AR1, the supply ports 12, and the exhaust ports 62. The second recovery port 32 may be similarly divided into a plurality and disposed.

One end part of the exhaust passageway 65 formed inside the nozzle holder 92 is connected to the other end part of the exhaust pipe 67 via a joint 66. In addition, the other end part of the exhaust passageway 65 is connected to one end part of an exhaust passageway 64 formed inside the first nozzle member 70. One end part of the exhaust passageway 65 of the nozzle holder 92 is provided to a side surface of the nozzle holder 92, and the other end part is provided to the lower surface 92A of the nozzle holder 92. In addition, one end part of the exhaust passageway 64 of the first nozzle member 70 is provided to the upper surface of the first nozzle member 70. Meanwhile, the other end part of the exhaust passageway 64 of the first nozzle member 70 is connected to the exhaust ports 62 formed in the lower surface 70A (cavity surface 78A) of the first nozzle member 70. Here, the exhaust passageway 64 formed inside the first nozzle member 70 branches midway so that it is capable of connecting its other end part with each of the plurality (two) of the exhaust ports 62 (62A, 62B).

Furthermore, by holding the first nozzle member 70 via the nozzle holder 92, one end part of the exhaust passageway 64 of the first nozzle member 70 and the other end part of the exhaust passageway 65 of the nozzle holder 92 are connected. Here, one end part of the exhaust passageway 65 formed inside the nozzle holder 92 is connected to the exhaust part 61 via the exhaust pipe 67. The other end part of the exhaust passageway 65 is connected to the exhaust ports 62, which are capable of discharging the gas on the image plane side of the projection optical system PL, via the exhaust passageway 64 formed inside the first nozzle member 70. Accordingly, the exhaust passageway 65 of the nozzle holder 92 is constituted so that it connects the exhaust part 61 and the first nozzle member 70.

In addition, as depicted in FIG. 4, a sealing member 133, which inhibits leakage of gas or the liquid LQ, is provided to the connection part between the exhaust passageway 65 of the nozzle holder 92 and the exhaust passageway 64 of the first nozzle member 70. The sealing member 133 can comprise an O ring and the like, the same as the sealing member 130. The provision of the sealing member 133 inhibits leakage of the gas or the liquid LQ, which flow through the exhaust passageways 64, 65, from the connection part.

The control apparatus CONT controls the exhaust operation of the exhaust part 61. To discharge the gas on the image plane side of the projection optical system PL, the control apparatus CONT drives the exhaust part 61 of the exhaust mechanism 60.

By driving the exhaust part 61, which has a vacuum system, the gas in a prescribed space on the image plane side of the projection optical system PL flows into the exhaust passageway 64 via the exhaust ports 62. The liquid LQ that flows into the exhaust passageway 64 flows through the exhaust passageway 65 of the nozzle holder 92, and is then suctioned and recovered by the exhaust part 61 via the exhaust pipe 67.

In addition, the control apparatus CONT drives the exhaust part 61, which has a vacuum system, and discharges (suctions) the gas on the image plane side of the projection optical system PL via the exhaust ports 62A, 62B disposed in the vicinity of the optical element 2 on the image plane side of the projection optical system PL, and it is thereby possible to negatively pressurize the space on the image plane side thereof.

In addition, as discussed above, the exhaust part 61 comprises a vacuum system and a gas-liquid separator, and it is consequently possible to recover the liquid LQ on the image plane side of the projection optical system PL via the exhaust ports 62A, 62B.

Accordingly, the exhaust mechanism 60 can discharge the gas on the image plane side of the projection optical system PL via the exhaust ports 62, and can also discharge (recover, eliminate) the bubbles (gas portions) in the liquid LQ in the immersion area AR2 along with the liquid LQ.

When using the exhaust mechanism 60 to recover the bubbles in the liquid LQ in the immersion area AR2, the control apparatus CONT drives the exhaust part 61 of the exhaust mechanism 60. By driving the exhaust part 61, which has the vacuum system, part of the liquid LQ in the immersion area AR2 formed on the image plane side of the projection optical system PL is suctioned and recovered via the exhaust ports 62. If bubbles are present in the liquid LQ, then those bubbles are suctioned and recovered through the exhaust ports 62 along with the liquid LQ.

As depicted in FIG. 4, the exhaust passageway 64, which is connected to the exhaust ports 62, forms an inclined surface 63 that gradually widens toward the exhaust port 62 in the vicinity thereof. Furthermore, a prescribed area, which is around the exhaust port 62, of the lower surface 70A of the nozzle member 70 comprises a recessed part 68, which is formed so that it is spaced apart from the substrate P. By providing the exhaust port 62 on the inner side of the recessed part 68, that exhaust port 62 is constituted so that it is provided at a position higher than the lower surface 70A surrounding the recessed part 68 with respect to the substrate P. Furthermore, an inclined surface 69, which gradually widens toward the substrate P side, is formed in the recessed part 68. In other words, the inner side surface of the recessed part 68 is formed so that it gradually widens toward the substrate P side.

By forming the exhaust port 62 on the inner side of the recessed part 68 and providing the exhaust port 62 at a position higher than the surrounding lower surface 70A (cavity surface 78A), even if bubbles (gas portions) are present in the liquid LQ in the immersion area AR2, those bubbles move upward in the liquid LQ due to the differential in the specific gravity between the liquid LQ and the bubbles, and are therefore smoothly and rapidly recovered by the exhaust port 62. In addition to forming the exhaust passageway 64, which is formed in the nozzle member 70 and connected to the exhaust ports 62, so that it gradually widens toward the exhaust port (outlet) 62 in the vicinity thereof, the inner side surface of the recessed part 68 formed around the exhaust port 62 is also formed inclined so that it gradually widens toward the substrate P side. For example, bubbles present in the vicinity of the optical element 2 and bubbles adhered to the lower surface 70A smoothly move to the exhaust port 62 along the inclined surface 69, the inclined surface 63, and the like, and are smoothly and rapidly recovered by the exhaust port 62. Furthermore, in the present embodiment, the connection part between the inclined surface 63 and the recessed part 68 is rounded and is constituted without any corners; therefore, the movement of the bubbles to the exhaust port 62 along the lower surface 70A (cavity surface 78A) is smooth.

In addition, as discussed above, the exhaust ports 62 are provided to the projection optical system PL (optical element 2) in the vicinity of the projection area AR1; consequently, the bubbles adhered to the optical element 2 and the bubbles suspended in the liquid LQ of the immersion area AR2 in the vicinity of the optical element 2 are smoothly and rapidly recovered through the exhaust ports 62. Accordingly, it is possible to prevent the problem of the presence of bubbles in the liquid LQ on the image plane side of the projection optical system PL.

Furthermore, by providing the exhaust mechanism 60 with a function that adds additional liquid LQ to the liquid LQ supplied from the liquid supply mechanism 10 and with a function that recovers part of the liquid LQ, the pressure of the liquid LQ supplied from the liquid supply mechanism 10 may be regulated by adding and partially recovering the liquid LQ via the exhaust ports 62.

An annular wall part 141 of the lower surface 70A of the first nozzle member 70 is formed on the outer side of the first recovery port 22 with respect to the projection area AR1. The wall part 141 is a protruding part that protrudes toward the substrate P side. In the present embodiment, the distance between the substrate P and the lower surface of the wall part 141 is substantially the same as the distance between the land surface 77 and the substrate P. The wall part 141 is capable of holding the liquid LQ in at least part of the area on its inner side. In addition, a second wall part 142 and a third wall part 143 of the lower surface 80A of the second nozzle member 80 are formed on the outer side of the wall part 141 with respect to the projection area AR1. The second recovery port 32 is provided on the inner side of a groove part formed between the second wall part 142 and the third wall part 143. These second and third wall parts 142, 143 prevent the outflow of the liquid LQ to the outer side of the lower surface 80A of the second nozzle member 80 (to the outer side of the substrate P).

In addition, the second nozzle member 80 is provided nearer to the substrate stage PST (or the substrate P supported by the substrate stage PST) than the first nozzle member 70. In other words, the distance between the lower surface 80A of the second nozzle member 80 and the upper surface 51 of the substrate stage PST (or the front surface of the substrate P supported by the substrate stage PST) is less than the distance between the lower surface 70A of the first nozzle member 70 and the upper surface 51 of the substrate stage PST.

In FIG. 5, the exposure apparatus EX comprises a focus leveling detection system 120 that detects the surface position information of the front surface of the substrate P, which is held by the substrate stage PST. The focus leveling detection system 120 is a so-called oblique incidence type focus leveling detection system and comprises: a light projecting part 121 that projects a detection beam La through the liquid LQ of the immersion area AR2 onto the substrate P from a diagonal direction; and a light receiving part 122 that receives the reflected light of the detection beam La that was reflected by the substrate P. Furthermore, it is possible to use the focus leveling detection system disclosed in, for example, Japanese Published Unexamined Patent Application No. H08-37149 as the constitution of the focus leveling detection system 120.

The light projecting part 121 of the focus leveling detection system 120 is provided at a position spaced apart from the projection optical system PL on the +Y side, and the light receiving part 122 is provided at a position spaced apart from the projection optical system PL on the −Y side. Namely, the light projecting part 121 and the light receiving part 122 are provided on opposite sides of the projection area AR1 of the projection optical system PL so that the projection area AR1 is interposed therebetween.

Recessed parts 92K, 92K, which are disposed so that one is on the −Y side and one is on the +Y side and are formed spaced apart from the upper surface of the first nozzle member 70, of the lower surface of the nozzle holder 92 are formed on opposite sides of the projection optical system PL, which is disposed in the holes 92H, 70H, so that it is interposed therebetween. Likewise, recessed parts 70K, 70K, which are disposed so that one is on the −Y side and one is on the +Y side and are formed spaced apart from the lower surface of the nozzle holder 92, of the upper surface of the first nozzle member 70 are formed on opposite sides of the projection optical system PL so that it is interposed therebetween. Furthermore, spaces 128, 129, which are disposed between the nozzle holder 92 and the first nozzle member 70 so that one of the spaces is on the −Y side and the other one is on the +Y side, are formed by the recessed parts 70K, 92K on opposite sides of the projection optical system PL so that it is interposed therebetween.

A first optical member 123 and a second optical member 124, which constitute part of the focus leveling detection system 120, are held by the first nozzle member 70. The first optical member 123 is capable of transmitting the detection beam La emitted from the light projecting part 121 of the focus leveling detection system 120, and the second optical member 124 is capable of transmitting the detection beam La reflected by the substrate P. The first and second optical members 123, 124 each comprise a prism member. The first nozzle member 70 has holes 123H, 124H wherein the first and second optical members 123, 124 can be disposed; in addition, in a state wherein these first and second optical members 123, 124 are disposed in the holes 123H, 124H, they are fixed to the first nozzle member 70 by holder mechanisms 125, 126. In addition, in the present embodiment, the first optical member 123 fixed to the first nozzle member 70 is provided on the +Y side of the projection optical system PL, and the second optical member 124 is provided on the −Y side.

In addition, the upper part of the first optical member 123 held by the first nozzle member 70 juts toward (protrudes toward) the space 128, and the lower part of the first optical member 123 juts out from an opening 123K formed in the cavity surface 78A of the lower surface 70A of the first nozzle member 70. Likewise, the upper part of the second optical member 124 held by the first nozzle member 70 juts toward (protrudes toward) the space 129, and the lower part of the second optical member 124 juts out from an opening 124K formed in the cavity surface 78A of the lower surface 70A of the first nozzle member 70.

The detection beam La emitted from the light projecting part 121 passes through the space 128 and then enters the upper part of the first optical member 123. The detection beam La that enters the upper part of the first optical member 123 has its optical path bent by the first optical member 123, and then passes through the opening 123K. Furthermore, the detection beam La is irradiated through the liquid LQ on the substrate P onto the front surface of the substrate P from a diagonal direction with a prescribed angle of incidence with respect to the optical axis AX of the projection optical system PL. The reflected light of the detection beam La reflected by the substrate P passes through the opening 124K, enters the second optical member 124, which bends its optical path, and then exits from the upper part of the second optical member 124. The detection beam La that exits from the upper part of the second optical member 124 passes through the space 129 and is then received by the light receiving part 122. In addition, by irradiating a plurality of detection beams La onto the substrate P from the light projecting part 121, the focus leveling detection system 120 can derive the focus position at each of a plurality of points (positions) on the substrate P in, for example, a matrix layout. Furthermore, based on the derived focus position at each of a plurality of points, it is possible to detect the positional information of the front surface of the substrate P in the Z axial direction, as well as the inclination information of the substrate P in the θX and θY directions.

The control apparatus CONT controls the position (focus position) of the substrate P, which is held by the substrate stage PST via the substrate holder PH, in the Z axial direction, as well as the positions in the θX, θY directions, by driving the substrate stage PST via the substrate stage drive apparatus PSTD based on the detection results of the focus leveling detection system 120. Namely, the substrate stage PST operates based on a command from the control apparatus CONT that is based on the detection results of the focus leveling detection system 120. Furthermore, by controlling the focus position (Z position) and the inclination angles of the substrate P, the front surface (surface to be exposed) of the substrate P is aligned in an optimal state with the plane of the image, which is formed through the projection optical system PL and the liquid LQ, by the auto focus system and the auto leveling system.

Furthermore, in the present embodiment, the detection beam La of the focus leveling detection system 120 is irradiated substantially parallel to the YZ plane, but may be irradiated substantially parallel to the XZ plane. In that case, the light projecting part 121 and the light receiving part 122 may be provided on opposite sides of the projection area AR1, one on the +X side and one on the −X side, so that the projection area AR1 is interposed therebetween; in addition, the first optical member 123 and the second optical member 124 may be provided on opposite sides of the projection area AR1, one on the +X side and one on the −X side, so that the projection area AR1 is interposed therebetween.

As discussed above, the first optical member 123 and the second optical member 124 constitute part of the optical system of the focus leveling detection system 120, as well as part of the first nozzle member 70. In other words, in the present embodiment, part of the first nozzle member 70 also serves as part of the focus leveling detection system 120.

Furthermore, by providing the recessed part 78 to the lower surface 70A of the first nozzle member 70, the focus leveling detection system 120 can smoothly irradiate the detection beam La to the desired area on the substrate P at the prescribed angle of incidence. If the present invention is constituted so that the recessed part 78 is not provided to the lower surface 70A of the first nozzle member 70, i.e., if the lower surface 70A of the first nozzle member 70 and the lower surface (liquid contact surface) 2A of the optical element 2 are flush, then problems arise, such as: the obstruction of the irradiation of the detection beam La by, for example, the disposal of the first nozzle member 70 in the optical path of the detection beam La if an attempt is made to irradiate the detection beam La of the focus leveling detection system 120 onto a prescribed area of the substrate P (specifically, for example, the projection area AR1 on the substrate P) at a prescribed angle of incidence; or the need to modify the angle of incidence to secure the optical path of the detection beam La, or the distance (working distance) between the front surface of the substrate P and the lower surface (liquid contact surface) 2A of the optical element 2 of the projection optical system PL. Nevertheless, providing the recessed part 78 of the lower surface 70A of the first nozzle member 70 to the lower surface 70A of the first nozzle member 70, which constitutes part of the focus leveling detection system 120, makes it possible to secure the optical path of the detection beam La of the focus leveling detection system 120 and to irradiate the detection beam La upon a prescribed area on the substrate P while maintaining the distance (working distance) between the front surface of the substrate P and the lower surface (liquid contact surface) 2A of the optical element 2 of the projection optical system PL at a prescribed value.

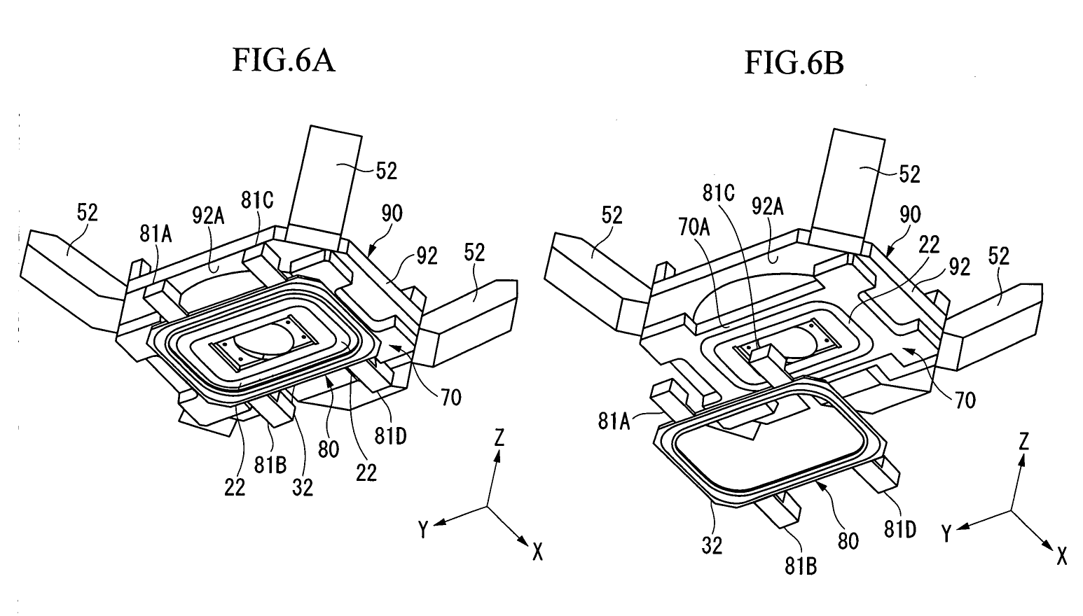

As discussed above, it is possible to separate the first nozzle member 70 and the second nozzle member 80 from the nozzle holding mechanism 90 (nozzle holder 92). FIG. 6A is an oblique view that depicts a state wherein the first nozzle member 70 and the second nozzle member 80 are each held by the nozzle holding mechanism 90, and FIG. 6B is an oblique view that depicts a state wherein the second nozzle member 80 is separated from the first nozzle member 70, which is held by the nozzle holding mechanism 90.

By providing the first nozzle member 70 and the second nozzle member 80 so that they are each capable of separating from the nozzle holding mechanism 90, which is fixed to the main column 1, it is possible to improve work efficiency when performing maintenance of these first and second nozzle members 70, 80, replacing them with new ones, and the like. Furthermore, it is also possible to rapidly implement appropriate measures if a problem arises with the first and second nozzle members 70, 80. Namely, with a constitution wherein the pipings 17, 27, 37, 67, and the like are attached directly to the first and second nozzle members 70, 80, it is necessary to perform the complicated procedure of separating those pipings (joints) and the first and second nozzle members 70, 80 when maintaining or replacing such. Incidentally, because the pipings are connected to the nozzle holding mechanism 90 (nozzle holder 92), and because the first and second nozzle members 70, 80 can be easily attached to and removed from the nozzle holder 92, the complicated procedure becomes unnecessary.

In addition, as discussed above, by connecting the nozzle holder 92 and the first and second nozzle members 70, 80 according to a prescribed positional relationship, it is possible to easily connect the internal passageway formed in the nozzle holder 92 and the internal passageways formed in the first and second nozzle members 70, 80. Here, the exposure apparatus EX comprises a positioning mechanism 91, which positions the nozzle holder 92 and the nozzle member 70. When connecting the nozzle holder 92 and the nozzle member 70, the positioning mechanism 91 is used to connect the nozzle member 70 to the nozzle holder 92 according to a prescribed positional relationship.

In the present embodiment, the positioning mechanism 91 comprises a plurality (three) of positioning members 91A to 91C, which are fixed to the lower surface of the nozzle holder 92 and are capable of contacting the side surface of the first nozzle member 70 when connecting the nozzle holder 92 and the first nozzle member 70, as depicted in FIG. 2. In the present embodiment, a positioning member 91A contacts the side surface of the first nozzle member 70 on the −Y side, and the positioning members 91B, 91C are provided so that they contact the side surface of the first nozzle member 70 on the +X side.

By providing the positioning mechanism 91, which positions the nozzle holder 92 and the first nozzle member 70, it is possible to satisfactorily connect the internal passageway formed in the nozzle holder 92 with the internal passageway formed in the first nozzle member 70. In addition, as discussed above, in the present embodiment, the first and second optical members 123, 124, which constitute part of the focus leveling detection system 120, are fixed to the first nozzle member 70, and there is consequently a possibility that the detection accuracy of the focus leveling detection system 120 will degrade if the position of the first nozzle member 70, which is provided with those first and second optical members 123, 124, shifts. Incidentally, because the first nozzle member 70 can be installed according to a prescribed positional relationship with respect to the nozzle holder 92 (as well as to the main column 1) by the positioning mechanism 91, which positions the first nozzle member 70 with respect to the nozzle holder 92 (nozzle holding mechanism 90) that is fixed to the main column 1, it is possible to also set the position of the first and second optical members 123, 124, which are provided to the first nozzle member 70, to a prescribed state. Accordingly, it is possible to prevent the problem wherein the detection accuracy of the focus leveling detection system 120 degrades.

In addition, by providing the positioning mechanism 91, it is possible to prevent fluctuations in the position of the supply ports 12, the first recovery port 22, and the like, even in cases such as when detaching the first nozzle member 70 from the nozzle holder 92 and then reattaching it to the nozzle holder 92. Accordingly, when attaching the first nozzle member 70 to the nozzle holder 92 after performing maintenance, when replacing the first nozzle member 70 with a new one, and the like, it is possible to prevent fluctuations in the position at which each of the supply ports 12 supply the liquid LQ, in the position at which the first recovery port 22 recovers the liquid LQ, and the like, and it is therefore possible to continuously supply and recover the liquid LQ under the same liquid supply and recovery position conditions.

In addition, in the present embodiment, the first nozzle member 70 is rigidly attached to the nozzle holder 92 of the nozzle holding mechanism 90. Accordingly, when the nozzle holding mechanism 90 is holding the first nozzle member 70, it is possible to prevent the occurrence of problems, such as a shift in the position of the first nozzle member 70 with respect to the nozzle holding mechanism 90, as well as fluctuations in the positions of the first and second optical members 123, 124, in the position at which each of the supply ports 12 supply the liquid LQ, in the position at which the first recovery port 22 recovers the liquid LQ, and the like.

The porous body 74 is disposed in the first recovery port 22 of the first nozzle member 70. It is preferable that the porous body 74 is lyophilic and that the size of the pores formed in the porous body 74 and the angle of contact between the porous body 74 and the liquid LQ are as small as possible. Furthermore, when recovering the liquid LQ, the generation of vibrations at the first nozzle member 70 is suppressed by suctioning and recovering only the liquid LQ from the first recovery port 22.

The second liquid recovery mechanism 30 recovers the liquid LQ that flows out to the outer side of the first recovery port 22 and that was not completely recovered by the first liquid recovery mechanism 20; in addition, the operation of recovering the liquid LQ (suction operation) as discussed above is performed continuously. Namely, when the first liquid recovery mechanism 20 is recovering the liquid LQ, the liquid LQ from the second recovery port 32 of the second nozzle member 80 is not recovered and only the gas (air) is recovered. Moreover, if the first liquid recovery mechanism 20 does not completely recover the liquid LQ and the liquid LQ flows out to the outer side of the first recovery port 22, then the liquid LQ is recovered together with the surrounding gas (so that the surrounding gas is taken in) via the second recovery port 32 of the second nozzle member 80. When recovering the liquid LQ via the second recovery port 32, there is a possibility that if that liquid LQ is recovered together with the surrounding gas (so that it is taken in), then the recovered liquid LQ will form droplets, strike the inner walls of the recovery passageways, the recovery pipes, and the like, and then generate vibrations (particularly high frequency vibration) at the second nozzle member 80. Therefore, in the present embodiment, by providing the connection mechanism 89 with elastic bodies 84, 85, which function as passive vibration isolating mechanisms, and by flexibly connecting the second nozzle member 80 to the nozzle holding mechanism 90, it is possible to effectively attenuate the transmission of vibrations generated by the second nozzle member 80 to the nozzle holding mechanism 90. In addition, in the present embodiment, a porous body 75 is likewise disposed in the second recovery port 32 of the second nozzle member 80, and that porous body 75 makes it possible to reduce the size of the droplets of the liquid LQ recovered via the second recovery port 32. Accordingly, even if the liquid LQ recovered via the second recovery port 32 forms droplets, strikes the inner walls of the recovery passageways, the recovery pipes, and the like, and then generates vibrations, it is possible to reduce the level of those vibrations.

Furthermore, in the present embodiment, the first and second nozzle members 70, 80 are constituted so that they are held by the nozzle holding mechanism 90, which is fixed to the main column 1, but the present invention is not limited thereto. For example, the present invention may be constituted so that the first and second nozzle members 70, 80 are directly attached in a mutually spaced apart state to the main column 1 (lower side step part 8) via, for example, a prescribed linking mechanism. Even in this case, it is preferable to constitute the linking mechanism so that the first and second nozzle members 70, 80 can be easily separated from the main column 1.

Furthermore, in the present embodiment, the porous bodies 74, 75 are provided to the first and second recovery ports 22, 32, respectively, but porous bodies may also be provided to the supply ports 12.

Here, in the present embodiment, the first nozzle member 70 and the second nozzle member 80 are both made of stainless steel. In addition, the porous bodies 74, 75 are made of stainless steel. Specifically, the first and second nozzle members 70, 80, which include the porous bodies 74, 75, are made of SUS316 (Cr 18%+Ni 12%+Mo 2%). The liquid contact surfaces of the first and second nozzle members 70, 80 that contact the liquid LQ of the immersion area AR2 preferably have a high affinity (lyophilicity) for the liquid LQ, the same as the liquid contact surface of the projection optical system PL (optical element 2). By making the liquid contact surface of the projection optical system PL (optical element 2) and the liquid contact surfaces of the first and second nozzle members 70, 80 lyophilic, it is possible to satisfactorily hold the liquid LQ between the substrate P (substrate stage PST) and the liquid contact surface of the projection optical system PL (optical element 2) as well as the liquid contact surfaces of the first and second nozzle members 70, 80, and to thereby form the immersion area AR2. In addition, by making the porous bodies 74, 75, which are disposed in the first and second recovery ports 22, 32, lyophilic, it is possible to satisfactorily recover the liquid LQ in the immersion area AR2. Because stainless steel (SUS316) is lyophilic, it is preferable to use such as a material for forming the first and second nozzle members 70, 80 and the porous bodies 74, 75.

In addition, stainless steel (SUS316) elutes only a small amount of impurities to the liquid LQ and has excellent corrosion resistance. In addition, stainless steel (SUS316) is highly rigid and it is consequently possible to increase the resonance frequency of the first and second nozzle members 70, 80, which are formed with this stainless steel. Generally, it is thought that the higher the frequency of the vibration component excited by the generated force, the smaller the impact on the exposure accuracy. Accordingly, it is preferable to form the first and second nozzle members 70, 80 with a stainless steel (SUS316) that has high rigidity, and to increase the resonance frequency of the first and second nozzle members 70, 80. In addition, because stainless steel (SUS316) is high strength steel, it is possible to prevent problems, such as deformation and breakage.

In addition, it is preferable to treat the first and second nozzle members 70, 80 in order to suppress the elution of impurities into the liquid LQ. Examples of such treatment include adhering chromium oxide to the first and second nozzle members 70, 80, e.g., the “GOLDEP” or “GOLDEP WHITE” treatments available from Shinko Pantec Co., Ltd. By performing such surface treatments, it is possible to further suppress the problem wherein impurities elute into the liquid LQ from the first and second nozzle members 70, 80, the porous bodies 74, 75, and the like. In addition, the treatment of adhering the abovementioned chromium oxide can be performed on areas that contact the liquid LQ, such as the porous bodies 74, 75, the lower surfaces 70A, 80A of the first and second nozzle members 70, 80, and the internal passageways formed in the first and second nozzle members 70, 80.

In addition, the abovementioned treatment is not limited to the first and second nozzle members 70, 80, the porous bodies 74, 75, and the like, e.g., the nozzle holder 92 may be made of stainless steel (SUS316), and at least the areas of that nozzle holder 92 that contact the liquid LQ (for example, the internal passageways of the nozzle holder 92) may be treated. Alternatively, it is of course also possible to perform the abovementioned treatment in addition to forming the members that contact the liquid LQ, such as the supply pipe 17, the recovery pipes 27, 37, and the exhaust pipe 67, of stainless steel.

Furthermore, the adhering of a fluororesin can be cited as a treatment performed on the first and second nozzle members 70, 80 in order to suppress the elution of impurities into the liquid LQ. Among fluororesins, the use PTFE (polytetrafluoroethylene), PFA (tetrafluoroethylene-perfluoroalkylvinylether copolymer), and the like are particularly preferable. Of course, the fluororesin may be adhered to the nozzle holder 92, the supply pipe 17, the recovery pipes 27, 37, the exhaust pipe 67, and the like.

In addition, in the present embodiment, the area of the tip surface 2A of the projection optical system PL (optical element 2) and of the lower surface 70A of the first nozzle member 70 that includes the first recovery port 22, the area that includes the land surface 77 and the cavity surface 78A on the inner side of the first recovery port 22, as well as the area of the lower surface 80A of the second nozzle member 80 that includes the second recovery port 32 are lyophilic. In addition, as discussed above, the porous bodies 74, 75 provided to the first recovery port 22 and the second recovery port 32, respectively, are lyophilic. Furthermore, in the present embodiment, the land surface 77 is lyophilic, but it may be liquid repellent.

The adhering of MgF₂, Al₂O₃, SiO₂, and the like can be cited as a treatment to make the abovementioned areas lyophilic. Alternatively, because the liquid LQ in the present embodiment is water, which has a high molecular polarity, the areas SR can also be lyophilically treated (hydrophilically treated) to impart hydrophilicity by, for example, forming a thin film with a substance that has a molecular structure with a high polarity, such as alcohol. Namely, if using water as the liquid LQ, then it is possible to use a process that provides the abovementioned areas SR with a thin film that has a molecular structure with a high polarity, such as the OH group.

Moreover, in the present embodiment, the area of the lower surfaces 70A, 80A of the first and second nozzle members 70, 80 on the outer side of the first recovery port 22 between the lyophilic area that includes the first recovery port 22 and the lyophilic area that includes the second recovery port 32, the area on the outer side of the second recovery port 32, the outer side surface 80S of the second nozzle member 80, and the like are liquid repellent.

In addition, in the present embodiment, the inner side surface 70T of the first nozzle member 70 and the side surface 2T of the optical element 2, which form a gap, are liquid repellent. Making the inner side surface 70T of the first nozzle member 70 and the side surface 2T of the optical element 2 liquid repellent prevents the infiltration of the liquid LQ in the immersion area AR2 into the gap formed by the inner side surface 70T and the side surface 2T. Likewise, making the outer side surface 70S of the first nozzle member 70 and the inner side surface 80T of the second nozzle member 80, which form a gap, liquid repellent prevents the infiltration of the liquid LQ in the immersion area AR2 into the gap formed by the outer side surface 70S and the inner side surface 80T.

Treatments that can be cited as liquid repellency treatments to make the abovementioned areas liquid repellent include, for example: applying a coat of a liquid repellent material, such as a fluororesin material like polytetrafluoroethylene, an acrylic resin material, and a silicone based resin material; affixing a thin film made of the abovementioned liquid repellent materials; and the like. Alternatively, instead of performing a liquid repellency treatment, it is possible to provide liquid repellency by, for example, forming part of the first and second nozzle members 70, 80 with a liquid repellent material, such as polytetrafluoroethylene, an acrylic resin, and the like.

In addition, the film for the surface treatment, which includes the abovementioned lyophilic treatment and liquid repellency treatment, may be a monolayer film or may be a film made of a plurality of layers. A material that is insoluble in the liquid LQ is used as the lyophilic material for imparting lyophilicity and the liquid repellent material for imparting liquid repellency.

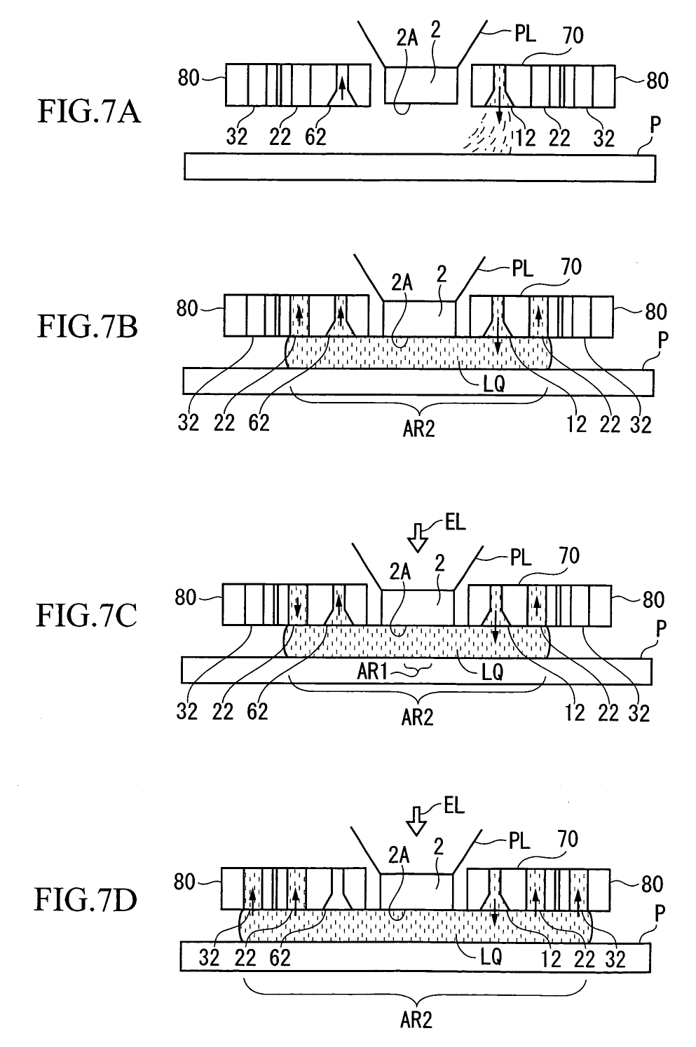

The following explains the method of exposing the substrate P with the pattern image of the mask M using the exposure apparatus EX constituted as discussed above, referencing the schematic drawings depicted in FIG. 7A to 7D.

When performing the scanning exposure process after the mask M is loaded onto the mask stage MST and the substrate P is loaded onto the substrate stage PST, the control apparatus CONT drives the liquid supply mechanism 10 to start the operation of supplying the liquid LQ onto the substrate P. The liquid LQ supplied from the liquid supply part 11 of the liquid supply mechanism 10 in order to form the immersion area AR2 is supplied to the image plane side of the projection optical system PL from the supply ports 12, as depicted in FIG. 7A.

Furthermore, prior to exposing the substrate P, the operation of supplying the liquid LQ when forming the immersion area AR2 on the image plane side of the projection optical system PL may be performed in a state wherein the projection optical system PL and the substrate P are mutually opposed, or in a state wherein the projection optical system PL and a prescribed area (e.g., the upper surface 51) on the substrate stage PST are mutually opposed. In addition, prior to exposing the substrate P, the immersion area AR2 on the image plane side of the projection optical system PL may be formed in a state wherein the substrate stage PST is stopped, or in a state wherein the substrate stage PST has been jogged.

When using the liquid supply mechanism 10 and starting the supply of the liquid LQ in order to form the immersion area AR2, the control apparatus CONT drives the first liquid recovery part 21 of the first liquid recovery mechanism 20 as well as the exhaust part 61 of the exhaust mechanism 60. By driving the exhaust part 61, which has a vacuum system, the gas in the space in the vicinity of the image plane side of the projection optical system PL is discharged (exhausted) from the exhaust ports 62, which are provided in the vicinity of the optical element 2 on the image plane side of the projection optical system PL, and that space is negatively pressurized. Thus, while driving the exhaust part 61 of the exhaust mechanism 60 and discharging the gas on the image plane side of the projection optical system PL through the exhaust ports 62 disposed in the projection optical system PL in the vicinity of the projection area AR1, the control apparatus CONT starts the supply of the liquid LQ by the liquid supply mechanism 10 in order to form the immersion area AR2.

Furthermore, as discussed above, the second liquid recovery mechanism 30 is continuously driven, and the suction operation is continuously performed by the second liquid recovery mechanism 30 through the second recovery port 32.

In the present embodiment, the recessed part 78 of the first nozzle member 70 is formed on the image plane side of the projection optical system PL. Consequently, when supplying the liquid LQ in order to form the immersion area AR2, the supplied liquid LQ does not enter into the recessed part 78, and gas portions, such as bubbles, are generated in the liquid LQ of the immersion area AR2, which raises the possibility that the gas will mix into the liquid LQ. However, in the present embodiment, it is possible to smoothly dispose the liquid LQ in the recessed part 78 because the supply of the liquid LQ is started by the liquid supply mechanism 10 while the gas on the image plane side of the projection optical system PL is discharged via the exhaust ports 62 that are disposed in the projection optical system PL in the vicinity of the projection area AR1. In other words, it is possible to smoothly dispose the supplied liquid LQ in that negatively pressurized area (space) by exhausting the gas from the exhaust ports 62 and negatively pressurizing the vicinity thereof. Accordingly, it is possible to prevent problems, such as the generation of gas portions in the immersion area AR2 formed on the image plane side of the projection optical system PL, or the mixing of bubbles into the liquid LQ used for forming the immersion area AR2. In addition, it is possible to satisfactorily cover the liquid contact surface 2A of the optical element 2 of the projection optical system PL disposed on the inner side of the recessed part 78 with the liquid LQ. Accordingly, high exposure and measurement accuracies can be obtained. In addition, even if gas portions, such as bubbles, are present in the liquid LQ, it is possible to prevent the problem of the mixing (presence) of bubbles in the liquid LQ because those bubbles (gas portions) can be eliminated by suctioning them via the exhaust ports 62.

In addition, by supplying the liquid LQ from the supply ports 12 that are provided to the cavity surface 78A of the recessed part 78 while exhausting the gas from the exhaust ports 62 that are provided to the cavity surface 78A of the recessed part 78, the liquid LQ can be rapidly filled in the recessed part 78 (the optical path of the exposure light EL). Accordingly, throughput can be improved.

In addition, in the present embodiment, in the lower surface 70A (cavity surface 78A) of the first nozzle member 70, a prescribed area surrounding each exhaust port 62, which is capable of discharging the gas, constitutes the recessed part 68, which is formed so that it is spaced apart from the substrate P. Consequently, even if bubbles (gas portions) are present in the supplied liquid LQ when the supply of the liquid LQ to the image plane side of the projection optical system PL has started, that gas moves upward due to the differential in the specific gravity between the gas and the liquid LQ, and the gas is thereby smoothly and rapidly discharged via the exhaust ports 62.

By supplying the liquid LQ via the supply ports 12 of the liquid supply mechanism 10 in parallel with recovering the liquid LQ via the first recovery port 22 of the first liquid recovery mechanism 20, the immersion area AR2 is eventually locally formed so that it is smaller than the substrate P and larger than the projection area AR1, and so that it includes the projection area AR1 between the projection optical system PL and the substrate P, as depicted in FIG. 7B. The immersion area AR2 of the liquid LQ is locally formed on part of the substrate P and is within an area surrounded by the substantially annular first recovery port 22 so that it includes the projection area AR1. Furthermore, the immersion area AR2 should cover at least the projection area AR1, but the entire area surrounded by the first recovery port 22 may not necessarily be an immersion area.

After forming the immersion area AR2, the control apparatus CONT irradiates the exposure light EL upon the substrate P in a state wherein the projection optical system PL and the substrate P are mutually opposed, and exposes the pattern image of the mask M upon the substrate P through the projection optical system PL and the liquid LQ, as depicted in FIG. 7C. When exposing the substrate P, the control apparatus CONT projects and exposes the pattern image of the mask M onto the substrate P through the projection optical system PL and the liquid LQ between the projection optical system PL and the substrate P while moving the substrate stage PST, which holds the substrate P, in the X axial direction (scanning direction), and while recovering the liquid LQ by the first liquid recovery mechanism 20 in parallel with supplying the liquid LQ by the liquid supply mechanism 10. At this time, the control apparatus CONT supplies the liquid LQ through the supply ports 12A, 12B while regulating the amount of the liquid LQ supplied per unit of time by the liquid supply mechanism 10. In addition, during the exposure of the substrate P, the control apparatus CONT uses the focus leveling detection system 120 to detect the positional information of the front surface of the substrate P through the liquid LQ, and performs the exposure while, for example, driving the substrate stage PST based on that detection result so that the image plane of the projection optical system PL is aligned with the front surface of the substrate P.

In the present embodiment, the supply passageway 14 of the liquid supply mechanism 10 forms an inclined surface 13 in the vicinity of each of the supply ports 12 that gradually widens toward the supply port 12, and the force of the liquid LQ, which is supplied onto the substrate P (substrate stage PST), against the substrate P is thereby distributed. Accordingly, it is possible to suppress the force exerted by the supplied liquid LQ upon the substrate P, the substrate stage PST, and the like. If the substrate P is deformed by the force exerted by the liquid LQ, then problems will arise, such as a degradation in the pattern image projected onto the substrate P, and a degradation in the measurement accuracy of the focus leveling detection system 120. In addition, if the edge area of the substrate P is pressed by the force of the liquid LQ when performing the immersion exposure of the edge area of the substrate P, then the height positions of the edge area of the substrate P and the upper surface 51 of the substrate stage PST will deviate and make it difficult to satisfactorily hold the liquid LQ on the image plane side of the projection optical system PL, which will thereby increase the possibility of the leakage of the liquid LQ. Incidentally, because the force of the liquid LQ exerted upon the substrate P is suppressed in the present embodiment, it is possible to prevent problems, such as the deformation of the substrate P by the supplied liquid LQ, as well as the leakage of the liquid LQ, and it is thereby possible to obtain high exposure and measurement accuracies.

Even during the exposure of the substrate P, the control apparatus CONT continues to recover part of the liquid LQ in the immersion area AR2 through the exhaust ports 62 of the exhaust mechanism 60. In so doing, even if for some reason bubbles have temporarily mixed into the liquid LQ in the immersion area AR2 during the exposure of the substrate P and gas portions are generated, those bubbles (gas portions) can be recovered and eliminated through the exhaust ports 62. In particular, because the exhaust ports 62 are disposed more in the vicinity of the optical element 2 of the projection optical system PL than the first recovery port 22, it is possible to quickly recover the bubbles and the like that are present in the vicinity of the optical element 2 of the projection optical system PL.

Furthermore, during the exposure of the substrate P, the recovery of part of the liquid LQ of the immersion area AR2 through the exhaust ports 62 by the exhaust mechanism 60 may be stopped.

After the immersion exposure of the substrate P ends, the control apparatus CONT recovers the liquid LQ remaining on the substrate P and on the substrate stage PST through the first recovery port 22 of the first liquid recovery mechanism 20, the second recovery port 32 of the second liquid recovery mechanism 30, and the exhaust ports 62 of the exhaust mechanism 60. Furthermore, after the operation of recovering the liquid LQ on the substrate P ends, the substrate P, for which the exposure process has finished, is unloaded from the substrate stage PST.

In addition, if the first liquid recovery mechanism 20 does not completely recover the liquid LQ in the immersion area AR2 on the substrate P through the first recovery port 22, then that incompletely recovered liquid LQ will flow out to the outer side of the first recovery port 22. However, as depicted in FIG. 7D, the liquid LQ is recovered through the second recovery port 32 by the second liquid recovery mechanism 30, and the outflow of the liquid LQ can therefore be prevented. Because the second liquid recovery mechanism 30 is continuously driven and the recovery operation (suction operation) is continuously performed, the liquid LQ can be reliably recovered. In addition, as discussed above, even if vibrations are generated when the liquid LQ is recovered through the second recovery port 32 of the second nozzle member 80, the transmission of the vibrations generated by the second nozzle member 80 to the nozzle holding mechanism 90 is suppressed because the connection mechanism 89 vibrationally isolates the second nozzle member 80 of the second liquid recovery mechanism 30 and the nozzle holding mechanism 90.

In addition, if some abnormality occurs in the first liquid recovery mechanism 20 and the liquid recovery operation becomes nonfunctional, or even in a case wherein the liquid supply mechanism 10 misoperates due to some abnormality, a large amount of the liquid LQ is unfortunately supplied and cannot be completely recovered by just the first liquid recovery mechanism 20, then the liquid LQ can be recovered by the second liquid recovery mechanism 30, and it is thereby possible to prevent the outflow of the liquid LQ. Accordingly, it is possible to prevent rusting of the mechanical parts caused by the liquid LQ that flowed out, electrical leakage in the drive system, or fluctuations in the environment wherein the substrate P is placed caused by the vaporization of the liquid LQ that flowed out, and it is thereby possible to prevent degradation in the exposure and measurement accuracies.

In addition, if it is determined, based on the detection result of the detector 150, that the liquid LQ was recovered through the second recovery port 32, i.e., if it is determined that the second liquid recovery mechanism 30 recovered the liquid LQ, then the control apparatus CONT may, for example, stop the supply of the liquid LQ by the liquid supply mechanism 10. Because there is a strong possibility that the liquid LQ will outflow when the second liquid recovery mechanism 30 has recovered the liquid LQ, the outflow of the liquid LQ can be prevented even in that case by stopping the supply of the liquid LQ by the liquid supply mechanism 10. Alternatively, if it is determined that the second liquid recovery mechanism 30 has recovered the liquid LQ, then the control apparatus CONT may stop the supply of electric power to the electrical equipment, starting with, for example, the actuator (linear motor) that drives the substrate stage PST. Because there is a strong possibility that the liquid LQ will outflow when the second liquid recovery mechanism 30 has recovered the liquid LQ, it is possible to prevent the occurrence of electrical leakage in that case even if the liquid LQ that flows out contacts the electrical equipment by stopping the supply of electrical power to the electrical equipment.

In addition, because the second liquid recovery mechanism 30 has an uninterruptible power supply 100B, even if an abnormality, such as a power outage, occurs at the service power supply 100A, which is the drive source of the entire exposure apparatus EX that includes the first liquid recovery mechanism 20, it is possible to satisfactorily recover the liquid LQ by the second liquid recovery mechanism 30 by switching the supply of electrical power thereto to the uninterruptible power supply 100B. Accordingly, the outflow of the liquid LQ can be prevented and the liquid LQ remaining on the substrate P can be recovered by the second liquid recovery mechanism 30 without leaving the liquid LQ on the substrate P, and it is therefore possible to prevent the occurrence of problems, such as: the rusting or breakdown of the mechanical parts surrounding the substrate stage PST, which supports the substrate P; and fluctuations in the environment wherein the substrate P is placed.

For example, if a power outage occurs at the service power supply 100A, then the uninterruptible power supply 100B will supply electric power to, for example, the electric drive part of the vacuum system, which constitutes the second liquid recovery mechanism 230, and the electric drive part of the gas-liquid separator. Specifically, if a power outage occurs at the service power supply 100A, the uninterruptible power supply 100B switches the supply of electrical power to the second liquid recovery mechanism 30 to, for example, a built-in battery, thus supplying power without interruption. Subsequently, in preparation for a long term power outage, the uninterruptible power supply 100B starts up a built-in generator and switches the supply of electrical power to the second liquid recovery mechanism 30 from the battery to the generator. In so doing, the supply of electrical power to the second liquid recovery mechanism 30 is continued even if a power outage occurs at the service power supply 100A, and it is thereby possible to maintain the operation of recovering the liquid LQ by the second liquid recovery mechanism 30. Furthermore, the present invention is not limited to the embodiment of the uninterruptible power supply 100B discussed above, and it is possible to adopt any well known uninterruptible power supply. In addition, although the present embodiment was explained as exemplified by using an uninterruptible power supply apparatus as a backup power supply for use when a power outage occurs at the service power supply 100A, a backup battery may of course be used as the backup power supply and the supply of electrical power may be switched to that battery in the event of a power outage at the service power supply 100A.

Furthermore, if a power outage occurs at the service power supply 100A, the uninterruptible power supply 100B may supply electric power to the chucking mechanism of the substrate holder PH, which holds the substrate P. In so doing, the chucking and holding of the substrate P by the substrate holder PH can be maintained even if a power outage occurs at the service power supply 100A, and the power outage therefore does not cause mispositioning of the substrate P with respect to the substrate stage PST. Accordingly, when resuming the exposure operation after recovering from the power outage, the operation of the exposure process can be smoothly resumed.

In addition, if a power outage occurs at the service power supply 100A, then the uninterruptible power supply 100B may supply electric power (drive power) to the various mechanisms (apparatuses) that constitute the exposure apparatus EX, with the exception of the second liquid recovery mechanism 30. For example, if a power outage occurs at the service power supply 100A, then it is possible to more reliably prevent the outflow of the liquid LQ by supplying electric power to the first liquid recovery mechanism 20 in addition to the second liquid recovery mechanism 30.

Furthermore, a normally closed type valve may be provided in advance to the supply pipe 17 of the liquid supply mechanism 10, and if a power outage occurs at the service power supply 100A, then that normally closed type valve may mechanically block the passageway of the supply pipe 17. In so doing, the problem of leakage of the liquid LQ from the liquid supply mechanism 10 onto the substrate P no longer occurs after a power outage occurs at the service power supply 100A.

Furthermore, in the embodiments discussed above, the amount of liquid LQ supplied per unit of time during the supply of such prior to the exposure of the substrate P (the state in FIGS. 7A and 7B), and the amount of liquid LQ supplied per unit of time during the supply of such during the exposure of the substrate P (the state in FIG. 7C) may be set to mutually differing values. For example, the amount of liquid LQ supplied prior to the exposure of the substrate P may be set so that it is greater than the amount of liquid LQ supplied during the exposure of the substrate P by, for example, setting the amount of liquid LQ supplied per unit of time prior to the exposure of the substrate P to approximately two L/min, and setting the amount of liquid LQ supplied per unit of time during the exposure of the substrate P to approximately 0.5 L/min. By increasing the amount of liquid LQ supplied prior to the exposure of the substrate P, even if bubbles adhere to, for example, the liquid contact surface 2A of the optical element 2, the lower surface 70A of the first nozzle member 70, or the front surface of the substrate P, those bubbles can be eliminated by the vigorousness of the flow of the liquid LQ. Furthermore, when exposing the substrate P after eliminating the bubbles (gas portions), the immersion area AR2 can be formed with the optimal liquid supply amount.

Similarly, the force (amount of liquid LQ suctioned per unit of time) of the suctioning through the exhaust ports 62 prior to the exposure of the substrate P and the force of the suctioning through the exhaust ports 62 during the exposure of the substrate P may be set to mutually differing values. For example, by setting the force of the suctioning through the exhaust ports 62 prior to the exposure of the substrate P so that it is stronger than the suction force during the exposure of the substrate P, it is possible to reliably suction, recover, and eliminate bubbles adhering to the liquid contact surfaces of the optical element 2 and the first nozzle member 70, bubbles adhering to the front surface of the substrate P, or bubbles (gas portions) suspended in the liquid LQ in the immersion area AR2. Furthermore, by performing the operation of suctioning through the exhaust ports 62 with the optimal suction force when exposing the substrate P, it is possible to recover and eliminate the liquid LQ and the bubbles therein via the exhaust ports 62 in a state wherein vibrations attendant with the suction operation are suppressed.

Furthermore, as discussed above, by providing the exhaust mechanism 60 with a function that adds more of the liquid LQ to the liquid LQ supplied by the liquid supply mechanism 10, and a function that recovers part of the liquid LQ, and by adding and partially recovering the liquid LQ via the exhaust ports 62, it is possible to regulate the pressure of the liquid LQ supplied by the liquid supply mechanism 10. In this case, a pressure sensor is provided in advance to the portions that contact the liquid LQ in the immersion area AR2, such as part of the lower surface 70A of the first nozzle member 70, and the pressure of the liquid LQ in the immersion area AR2 is continuously monitored by the pressure sensor during the immersion exposure of the substrate P. Furthermore, based on the detection result of the pressure sensor, the control apparatus CONT may use the exhaust mechanism 60 to regulate the pressure of the liquid LQ supplied by the liquid supply mechanism 10 onto the substrate P during the immersion exposure thereof. The force exerted by the liquid LQ upon the substrate P is thereby reduced.

Furthermore, the embodiments discussed above explained a case wherein the immersion area AR2 of the liquid LQ is formed on the substrate P, but the present invention is not limited thereto. A constitution is conceivable wherein a fiducial member provided with a fiducial mark that is measured by a substrate alignment system, such as the one disclosed in Japanese Published Unexamined Patent Application No. H04-65603, and a fiducial mark that is measured by a mask alignment system, such as the one disclosed in Japanese Published Unexamined Patent Application No. H07-176468, is disposed on the substrate stage PST, and the immersion area AR2 of the liquid LQ is formed on that fiducial member. Furthermore, a constitution is conceivable wherein various measurement processes are performed through the liquid LQ in the immersion area AR2 on that fiducial member. Even in such a case, the exposure apparatus EX according to the present embodiment can perform the measurement processes with good accuracy in a state wherein the force exerted upon the fiducial member is suppressed. Likewise, a constitution is conceivable wherein a luminous flux intensity nonuniformity sensor, such as the one disclosed in Japanese Published Unexamined Patent Application No. S57-117238, an aerial image measuring sensor, such as the one disclosed in Japanese Published Unexamined Patent Application No. 2002-14005, and an irradiance sensor (luminous flux intensity sensor), such as the one disclosed in Japanese Published Unexamined Patent Application No. H11-16816, are provided as optical sensors on the substrate stage PST; in addition, a constitution is conceivable wherein the immersion area AR2 of the liquid LQ is formed on these optical sensors and various measurements are performed through the liquid LQ. Even in this case, the exposure apparatus EX according to the present embodiment can perform the measurement processes with good accuracy in a state wherein the force exerted upon the optical sensors is suppressed.

Incidentally, as discussed above, the second nozzle member 80 is provided so that it is closer to the substrate stage PST (or the substrate P) than the first nozzle member 70. In so doing, even if for some reason an abnormality occurs in the positional relationship between the substrate stage PST, the projection optical system PL, and the nozzle members 70, 80, e.g., a failure in the positional control of the substrate stage PST in the Z axial direction, it is possible to prevent a collision between the first nozzle member 70 or the projection optical system PL and the substrate stage PST.

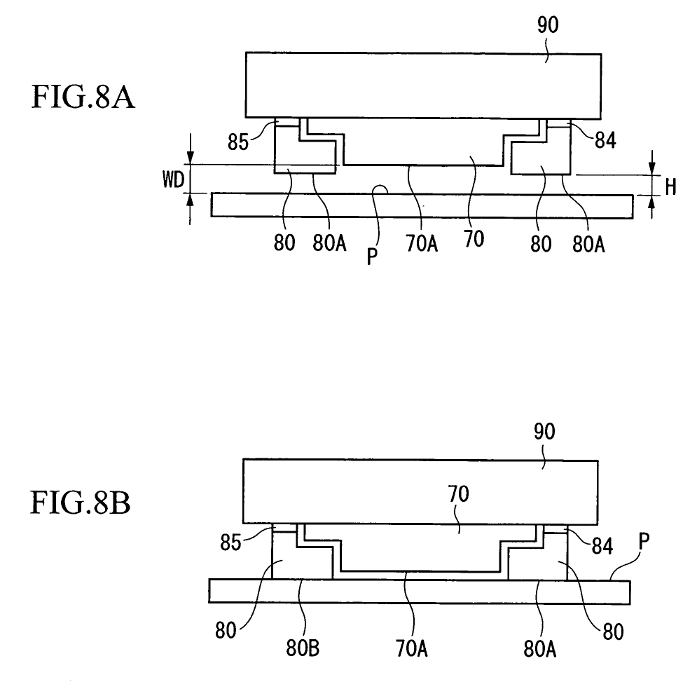

FIGS. 8A and 8B are schematic drawings for the purpose of explaining the positional relationship between the substrate P, which is supported by the substrate stage PST, the first nozzle member 70, and the second nozzle member 80. As depicted in FIG. 8A, the distance H between the lower surface 80A of the second nozzle member 80 and the substrate P is less than the distance W1 between the lower surface 70A of the first nozzle member 70 and the substrate P, and the second nozzle member 80 is provided closer to the substrate P than the first nozzle member 70. In this case, if, for example, the positional control of the substrate stage PST, which supports the substrate P, fails and the substrate P rises as depicted in FIG. 8B, then the substrate P will strike the second nozzle member 80, but will not strike the projection optical system PL, the first nozzle member 70, and the like. If the substrate P (substrate stage PST) strikes the optical element 2 of the projection optical system PL, then problems will arise, such as damage to the optical element 2, shaking of the entire projection optical system PL, which displaces the optical elements that constitute the projection optical system PL, modification of the optical characteristics of the projection optical system PL, and the like. In addition, if the substrate P (substrate stage PST) strikes the first nozzle member 70, then problems will arise, such as damage to the lower surface 70A of the first nozzle member 70 and fluctuations in the position of the first nozzle member 70. The first recovery port 22 and the supply ports 12 for forming the immersion area AR2 are formed in the lower surface 70A of the first nozzle member 70, and if the lower surface 70A of that first nozzle member 70 is damaged, then there is a possibility that the immersion area AR2 will no longer be able to be smoothly formed. In addition, if the position of the first nozzle member 70 fluctuates, then problems will arise, such as fluctuations in the position at which the supply ports 12 supply the liquid LQ, fluctuations in the position at which the first recovery port 22 recovers the liquid, and fluctuations in the position of the optical element 2 due to the side surface 2T of the optical element 2 and the inner side surface 70T of the first nozzle member 70 striking one another. In addition, because the first nozzle member 70 holds the first optical member 123 and the second optical member 124, which constitute part of the focus leveling detection system 120, the measurement accuracy of the focus leveling detection system 120 will degrade if the position of that first nozzle member 70 fluctuates.

In the present embodiment, by providing the second nozzle member 80 closer to the substrate stage PST (substrate P) than the first nozzle member 70 and the projection optical system PL, a collision between the substrate stage PST (substrate P) and the first nozzle member 70 or the projection optical system PL is avoided and, in so doing, it is possible to prevent the occurrence of the abovementioned problems. In addition, the elastic bodies 84, 85, which function as a cushioning mechanism that absorbs the shock in the event that the substrate stage PST (substrate P) collides with the second nozzle member 80, are provided between the second nozzle member 80 and the nozzle holding mechanism 90. Accordingly, even in the event that the substrate stage PST (substrate P) collides with the second nozzle member 80, the elastic bodies 84, 85 absorb the shock, and therefore the nozzle holding mechanism 90 as well as the lower side step part 8 (main column 1) that supports such are not strongly vibrated. Accordingly, the projection optical system PL, which is supported by the lower side step part 8 via the lens barrel base plate 5, is not strongly vibrated.

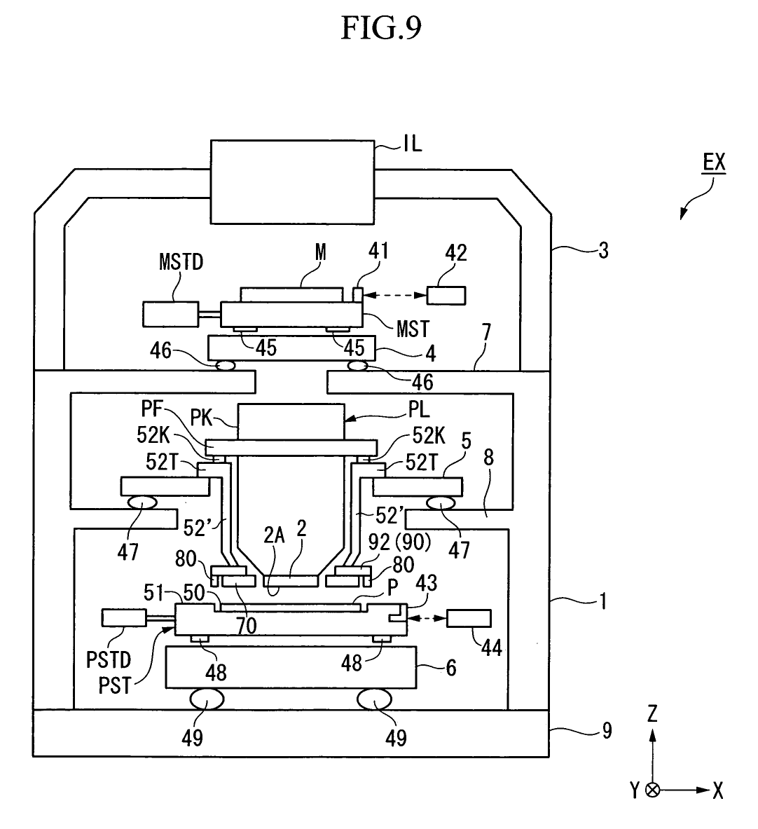

FIG. 9 depicts another embodiment of the nozzle holding mechanism 90 of the present invention. The characteristic portion of the embodiment depicted in FIG. 9 lies in the fact that the nozzle holder 92 of the nozzle holding mechanism 90, which holds the first and second nozzle members 70, 80, is supported by the lens barrel base plate 5 via a frame 52′. The frame 52′ depicted in FIG. 9 has at its upper part a flange part 52T, which is installed on the lens barrel base plate 5. The flange part PF of the lens barrel PK of the projection optical system PL is kinematically supported on the flange part 52T of the frame 52′ via a support member 52K. Furthermore, the nozzle holder 92 of the nozzle holding mechanism 90 is fixed to a lower part of the frame 52′. Thus, the nozzle holding mechanism 90, which holds the first and second nozzle members 70, 80, may be constituted so that it is supported by the lens barrel base plate 5, which is for the purpose of supporting the projection optical system PL.

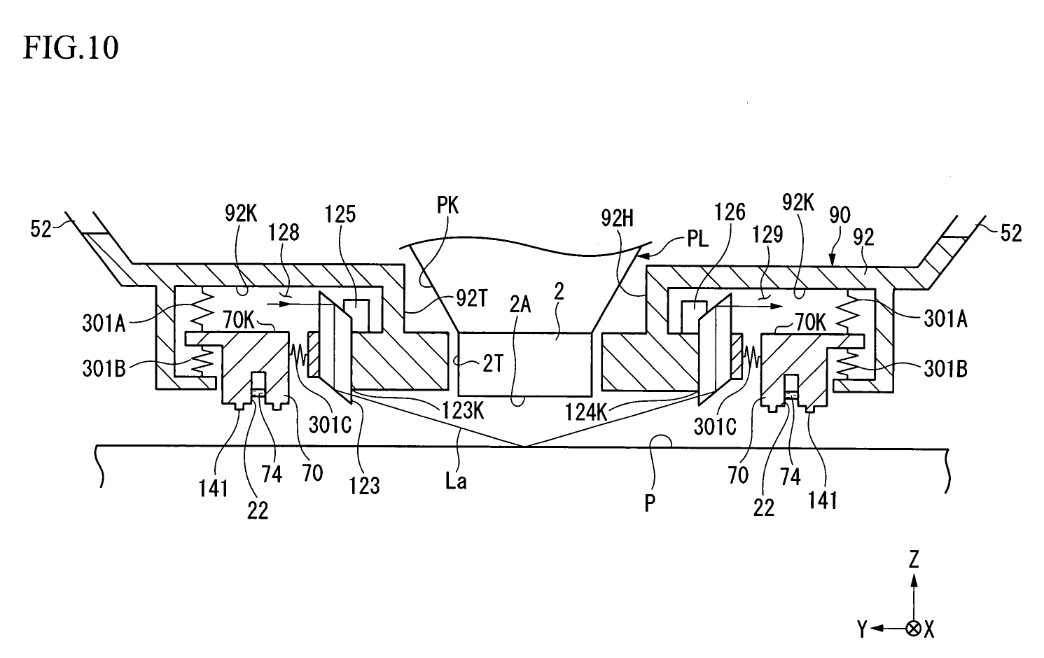

In addition, the portion of the first nozzle member 70 that has the supply ports 12 and the first recovery port 22, which supply and recover the liquid LQ, may be constituted so that it separates and supports the first and second optical members 123, 124. FIG. 10 is a schematic view that depicts one example of a constitution wherein the first and second optical members 123, 124 are separated from the first nozzle member 70, the first and second optical members 123, 124 are fixed to the nozzle holder 92, and the first nozzle member 70 is flexibly (elastically) supported with respect to the nozzle holder 92. Furthermore, to facilitate understanding of the explanation, the second nozzle member 80 is omitted from FIG. 10. As depicted in FIG. 10, the first nozzle member 70 is supported by connecting members 301A, 301B in the Z axial direction with respect to the nozzle holder 92, and is supported by a connecting member 301C in the Y axial direction (horizontal direction) with respect to the nozzle holder 92. The connecting members 301A-301C each comprise an elastic member, such as a comparatively weak spring, rubber, or a bellows. In addition, the connecting members 201A-201C may each comprise a member, such as a damper, that has the characteristics of a viscous fluid. A lower surface of the first nozzle member 70 is provided closer to the substrate stage PST (or the substrate P) than the first and second optical members 123, 124.

Because the connecting members 301A to 301C function as a vibration isolating mechanism, similar to the elastic bodies 84, 85 in the second nozzle member 80 explained previously, the first nozzle member 70 and the nozzle holder 92 are vibrationally isolated. Accordingly, it is possible to attenuate the vibrations generated by the first nozzle member 70 so that they do not transmit to the nozzle holder 92. As a result, it is possible to suppress the transmission of the vibrations generated by the first nozzle member 70 to the first and second optical members 123, 124, the projection optical system PL, and the like. These connecting members 301A-301C function as a passive type vibration isolating mechanism and can attenuate the high frequency band of the vibrations. In addition, similar to the connection mechanism 89 of the second nozzle member 80, an actuator and the like may be added to the connecting members 301A to 301C to constitute an active type vibration isolating mechanism, and may thereby attenuate the lower harmonic band vibrations.

Even if we assume, based on the constitution described above, that the first nozzle member 70 and the substrate stage PST (substrate P) collide (a case wherein the operation by the previously discussed second nozzle member 80 avoiding a collision with the first nozzle member 70 did not function), the first nozzle member 70 can perform a withdrawal operation (e.g., move in the Z axial direction) after the collision by the elastic effect of the connecting members 301A to 301C. Consequently, the shock at the time of the collision can be absorbed, and the first nozzle member 70 along with the nozzle holder 92 that supports such are not strongly vibrated. In addition, at this time, the first and second optical members 123, 124, the optical element 2, and the like do not collide with the substrate stage PST (substrate P) before the first nozzle member 70. Thereby, it is possible to suppress the impact of the collision upon the projection optical system PL, the first and second optical members 123, 124, and the like.

If the throughput of the exposure apparatus EX is improved by increasing the travel speed of the substrate stage PST, then it is preferable to reduce as much as possible the distance (working distance) between the lower surface of the nozzle members and the substrate P in the Z axial direction in order to maintain the immersion area AR2 in the prescribed state. However, if the working distance is reduced, there is an increased possibility that the nozzle members and the substrate stage PST (substrate P) will collide (make contact), and a constitution is therefore necessary to minimize the impact of a collision should one occur. By adopting the constitution as depicted in FIG. 10, it is possible to suppress the impact of the collision, should one occur, while reducing the working distance.

As discussed above, the liquid LQ in the present embodiment comprises pure water. Pure water is advantageous because it can be easily obtained in large quantities at a semiconductor fabrication plant and the like, and because pure water has no adverse impact on the optical element (lens), the photoresist on the substrate P, and the like. In addition, because pure water has no adverse impact on the environment and has an extremely low impurity content, it can also be expected to have the effect of cleaning the front surface of the substrate P and the surface of the optical element provided on the tip surface of the projection optical system PL. Furthermore, the exposure apparatus may be provided with an ultrapure water manufacturing apparatus if the purity of the pure water supplied from the plant and the like is low.

Furthermore, the liquid supply mechanism 10 comprises a temperature regulating mechanism (not shown) that regulates the liquid LQ, and is constituted so that the liquid LQ is supplied onto the substrate P at a temperature (23° C.) substantially the same as the temperature inside the chamber wherein the exposure apparatus EX is housed. If the space inside the abovementioned chamber is insufficient, then this temperature regulating mechanism is installed at a position spaced apart from the first nozzle member 70, which comprises the supply ports 12. In this case, it is preferable to insulate the passageway (supply pipe 17) from the surrounding space so that the temperature of the liquid LQ does not change midway as the liquid LQ proceeds from the temperature regulating mechanism to the first nozzle member 70 through the passageway (supply pipe 17). Even if the interior of the chamber is set to the prescribed temperature, there is a possibility that if, for example, heat is locally generated and the passageway (supply pipe 17) of the liquid LQ is disposed in the vicinity of that locally generated heat, then the temperature regulating mechanism of the chamber will be affected by that heat generation during the interval until the temperature inside the chamber returns to the set value, which will unfortunately vary the temperature of the liquid LQ from its regulated value. Accordingly, the passageway (supply pipe 17) may be housed in the bellows, and the interior of the bellows may be set to a vacuum state so that the passageway (supply pipe 17) is not affected by external heat. In addition, by covering the circumference of the supply pipe 17 with a heat insulating material, the liquid LQ that flows inside the supply pipe 17 is not affected by heat.

Further, the refractive index n of pure water (water) for the exposure light EL that has a wavelength of approximately 193 nm is said to be substantially 1.44; therefore, the use of ArF excimer laser light (193 nm wavelength) as the light source of the exposure light EL would shorten the wavelength on the substrate P to 1/n, i.e., approximately 134 nm, and thereby a high resolution would be obtained. Furthermore, because the depth of focus will increase approximately n times, i.e., approximately 1.44 times, that of in air, the numerical aperture of the projection optical system PL can be further increased if it is preferable to ensure a depth of focus approximately the same as that when used in air, and the resolution is also improved from this standpoint.

Furthermore, the numerical aperture NA of the projection optical system may become 0.9 to 1.3 if the liquid immersion method as discussed above is used. If the numerical aperture NA of such a projection optical system increases, then random polarized light conventionally used as the exposure light will degrade imaging performance due to the polarization effect, and it is therefore preferable to use polarized illumination. In that case, it is better to illuminate with linearly polarized light aligned in the longitudinal direction of the line pattern of the line-and-space pattern of the mask (the reticle), and to emit a large amount of diffracted light of the S polarized light component (the TE polarized light component) i.e., the polarized light direction component aligned in the longitudinal direction of the line pattern, from the pattern of the mask (the reticle). If a liquid is filled between the projection optical system PL and the resist coated on the front surface of the substrate P, then the transmittance through the resist surface increases for the diffracted light of the S polarized light component (the TE polarized light component), which contributes to the improvement of the contrast, compared with the case in which air (a gas) is filled between the projection optical system PL and the resist coated on the front surface of the substrate P. Consequently, a high imaging performance can be obtained even if the numerical aperture NA of the projection optical system exceeds 1.0. In addition, it is further effective to appropriately combine a phase shift mask and the oblique incidence illumination method (particularly the dipole illumination method) aligned in the longitudinal direction of the line pattern, as disclosed in Japanese Published Patent Application No. H06-188169. This is particularly effective in cases such as when combining the linear polarized light illumination method and the dipole illumination method, and the direction of periodicity of the line-and-space pattern is limited to a prescribed single direction, or when the hole pattern is concentrated along a prescribed single direction. For example, in a case where a half tone phase shift mask (a pattern with an approximately 45 nm half pitch) having a transmittance of 6% is illuminated using the linear polarized light illumination method and the dipole illumination method in parallel, then the depth of focus (DOF) can be increased by approximately 150 nm more than when using random polarized light if the σ of the illumination stipulated by the circumscribed circle of the dual beam that forms the dipole in the pupil plane of the illumination system is 0.95, the radius of each beam in that pupil plane is 0.125 σ, and the numerical aperture NA of the projection optical system PL is 1.2.

In addition, if a fine line-and-space pattern (e.g., a line-and-space of approximately 25 to 50 nm) is exposed on the substrate P using, for example, an ArF excimer laser as the exposure light and using a projection optical system PL that has a reduction magnification of approximately ¼, then the structure of the mask M (e.g., the fineness of the pattern and the thickness of the chrome) causes the mask M to act as a polarizing plate due to the wave guide effect, and a large amount of diffracted light of the S polarized light component (the TE polarized light component) from the diffracted light of the P polarized light component (the TM polarized light component), which decreases contrast, is emitted from the mask M. In this case, it is preferable to use the linear polarized light illumination discussed above; however, even if the mask M is illuminated with random polarized light, a high resolution performance can be obtained even if the numerical aperture NA of the projection optical system PL is as large as 0.9 to 1.3.

In addition, if exposing an ultrafine line-and-space pattern of a mask M onto a substrate P, then there is also a possibility that the P polarized light component (the TM polarized light component) will become greater than the S polarized light component (the TE polarized light component) due to the wire grid effect. However, because a greater quantity of diffracted light of the S polarized light component (the TE polarized light component) than the diffracted light of the P polarized light component (the TM polarized light component) is emitted from the mask M if a line-and-space pattern larger than 25 nm is exposed onto the substrate P using, for example, an ArF excimer laser as the exposure light and a projection optical system PL that has a reduction magnification of approximately ¼, a high imaging performance can be obtained even if the numerical aperture NA of the projection optical system PL is as large as 0.9 to 1.3.

Furthermore, instead of just linear polarized light illumination (S polarized light illumination) aligned in the longitudinal direction of the line pattern of the mask (the reticle), it is also effective to combine the oblique incidence illumination method with the polarized light illumination method that linearly polarizes light in a direction tangential (circumferential) to a circle with the optical axis at the center, as disclosed in Japanese Published Patent Application No. H06-53120. In particular, if the mask (reticle) pattern includes line patterns extending in a plurality of differing directions instead of just a line pattern extending in a prescribed single direction (mixing line-and-space patterns that have differing directions of periodicity), then, by combining the use of the zonal illumination method with the polarized light illumination method that linearly polarizes light in a direction tangential to a circle that has the optical axis at its center, as similarly disclosed in Japanese Published Patent Application No. H06-53120, it is possible to achieve high imaging performance even if the numerical aperture NA of the projection optical system is large. For example, if illuminating a half tone phase shift mask (pattern with an approximately 63 nm half pitch) that has a transmittance of 6% by combining the use of the zonal illumination method (¾ zonal ratio) with the polarized light illumination method that linearly polarizes light in a direction tangential to a circle with the optical axis at its center, then the depth of focus (DOF) can be increased by approximately 250 nm more than when using random polarized light if the a of the illumination is 0.95 and the numerical aperture NA of the projection optical system PL is 1.00, and the depth of focus can be increased by approximately 100 nm if the numerical aperture NA of the projection optical system PL is 1.2 with a pattern that has an approximately 55 nm half pitch.

In the present embodiment, the optical element 2 is affixed at the tip of the projection optical system PL and can adjust the optical characteristics of the projection optical system PL, e.g., aberrations (spherical aberration, coma aberration, and the like). Furthermore, the optical element affixed to the tip of the projection optical system PL may also be an optical plate used to adjust the optical characteristics of the projection optical system PL. Alternatively, it may be a plane parallel plate that is capable of transmitting the exposure light EL therethrough.

Furthermore, if high pressure is generated by the flow of the liquid LQ between the substrate P and the optical element at the tip of the projection optical system PL, then instead of making the optical element replaceable, it may be firmly fixed by that pressure so that it does not move.

Furthermore, the present embodiment is constituted so that the liquid LQ is filled between the projection optical system PL and the front surface of the substrate P, but it may be constituted so that the liquid LQ is filled in a state wherein, for example, a cover glass comprising a plane parallel plate is affixed to the front surface of the substrate P.

Furthermore, although the liquid LQ in the present embodiment is water, it may be a liquid other than water; for example, if the light source of the exposure light EL is an F₂ laser, then this F₂ laser light will not transmit through water, so it would be acceptable to use as the liquid LQ a fluorine based fluid, such as perfluorinated polyether (PFPE) or fluorine based oil, that is capable of transmitting F₂ laser light. In this case, the parts that make contact with the liquid LQ are treated in order to make them lyophilic by forming a thin film with a substance that has a molecular structure that contains fluorine and that has a low polarity. In addition, it is also possible to use as the liquid LQ one (e.g., cedar oil) that is transparent to the exposure light EL, has the highest possible refractive index, and is stable with respect to the projection optical system PL and the photoresist coated on the front surface of the substrate P. In this case as well, the surface treatment is performed in accordance with the polarity of the liquid LQ used.

Furthermore, the substrate P in each of the abovementioned embodiments is not limited to a semiconductor wafer for fabricating semiconductor devices, and is also applicable to a glass substrate for a display device, a ceramic wafer for a thin film magnetic head, a mask or the original plate of a reticle (synthetic quartz, silicon wafer) used by an exposure apparatus, and the like.

The exposure apparatus EX of the present invention can also be adapted to a step-and-scan system scanning type exposure apparatus (scanning stepper) that scans and exposes the pattern of the mask M by synchronously moving the mask M and the substrate P, as well as a step-and-repeat system projection exposure apparatus (stepper) that exposes the full pattern of the mask M, with the mask M and the substrate P in a stationary state, and sequentially steps the substrate P.

In addition, the exposure apparatus EX of the present invention can also be adapted to an exposure apparatus that exposes a reduced image of the full field of a first pattern onto the substrate P using a projection optical system (e.g., a refraction type projection optical system, which does not include a reflecting element, with a ⅛ reduction magnification) in a state wherein the first pattern and the substrate P are substantially stationary. In this case, the exposure apparatus EX can also be adapted to a stitching type exposure apparatus that subsequently further uses that projection optical system to expose a reduced image of the full field of a second pattern, in a state wherein the second pattern and the substrate P are substantially stationary, onto the substrate P, partially overlapping the first pattern. In addition, as a stitching type apparatus, the present invention can also be adapted to a step-and-stitch system exposure apparatus that partially and superimposingly transfers at least two patterns onto the substrate P, and sequentially steps such.

In addition, the present invention can also be adapted to a twin stage type exposure apparatus as disclosed in Japanese Published Unexamined Patent Application No. H10-163099, Japanese Published Unexamined Patent Application No. H10-214783, Published Japanese Translation No. 2000-505958 of the PCT International Publication, and the like.

In addition, although the embodiments discussed above adopt an exposure apparatus that locally fills the liquid LQ between the projection optical system PL and the substrate P, the present invention can also be adapted to an immersion exposure apparatus that moves a stage, which holds the substrate to be exposed, in a liquid bath, as disclosed in Japanese Published Unexamined Patent Application No. H06-124873.

The type of exposure apparatus EX is not limited to semiconductor device fabrication exposure apparatuses that expose the pattern of a semiconductor device on the substrate P, but can also be widely adapted to exposure apparatuses for fabricating liquid crystal devices or displays, exposure apparatuses for fabricating thin film magnetic heads, imaging devices (CCDs), or reticles and masks, and the like.

The exposure apparatus EX of the embodiments in the present application is manufactured by assembling various subsystems, including each constituent element recited in the claims of the present application, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes the mutual mechanical connection of the various subsystems, the wiring and connection of electrical circuits, the piping and connection of the atmospheric pressure circuit, and the like. Naturally, before the process of assembling the exposure apparatus from these various subsystems, there are also the processes of assembling each individual subsystem. When the process of assembling the exposure apparatus from the various subsystems is finished, a comprehensive adjustment is performed to ensure the various accuracies of the exposure apparatus as a whole. Furthermore, it is preferable to manufacture the exposure apparatus in a clean room wherein the temperature, the cleanliness level, and the like are controlled.

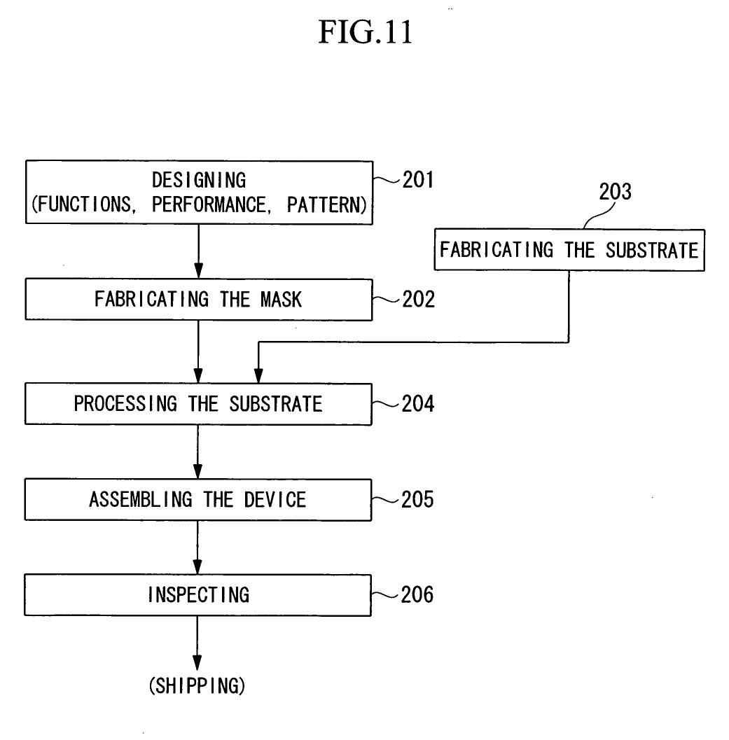

As shown in FIG. 11, a micro-device, such as a semiconductor device, is manufactured by: a step 201 that designs the functions and performance of the micro-device; a step 202 that fabricates a mask (reticle) based on this design step; a step 203 that fabricates a substrate, which is the base material of the device; an exposure processing step 204 wherein the exposure apparatus EX of the embodiments discussed above exposes a pattern of the mask onto the substrate; a device assembling step 205 (comprising a dicing process, a bonding process, and a packaging process); an inspecting step 206; and the like.

What is claimed is:

1. An exposure apparatus that exposes a substrate through a liquid, comprising:
a first nozzle member, which is provided in the vicinity of the image plane side of the projection optical system that at least has either a supply port that supplies the liquid or a first recovery port that recovers the liquid; and
a second nozzle member, which is provided on the outer side of the first nozzle member with respect to a projection area of the projection optical system, that has a second recovery port, which recovers the liquid, that is separate from the first recovery port; wherein,
the first nozzle member and the second nozzle member are mutually independent members.

2. An exposure apparatus according to claim 1, comprising:
a nozzle holding mechanism that separably holds the first nozzle member and the second nozzle member.

3. An exposure apparatus according to claim 2, wherein
the nozzle holding mechanism holds the first nozzle member and the second nozzle member so that they are spaced apart.

4. An exposure apparatus according to claim 2, comprising:
a connection mechanism that movably connects the second nozzle member to the nozzle holding mechanism.

5. An exposure apparatus according to claim 4, wherein
the connection mechanism flexibly connects the second nozzle member to the nozzle holding mechanism.

6. An exposure apparatus according to claim 5, wherein
the connection mechanism vibrationally isolates the second nozzle member and the nozzle holding mechanism.

7. An exposure apparatus according to claim 6, wherein
the connection mechanism attenuates the vibrations of the second nozzle member so that they do not transmit to the nozzle holding mechanism.

8. An exposure apparatus according to claim 4, wherein
the connection mechanism comprises an elastic body.

9. An exposure apparatus according to claim 1, comprising:
a surface position detection system that detects surface position information of the substrate; wherein,
the first nozzle member holds at least one optical member of the plurality of optical members that constitute the surface position detection system.

10. An exposure apparatus according to claim 1, wherein
the nozzle holding mechanism is supported by a support member that supports the projection optical system.

11. An exposure apparatus according to claim 1, comprising:
a substrate stage that supports the substrate; wherein, the second nozzle member is provided closer to the substrate stage than the first nozzle member.

12. An exposure apparatus according to claim 11, comprising:
a cushioning mechanism that absorbs the shock in the event that the substrate or the substrate stage collides with the second nozzle member.

13. An exposure apparatus according to claim 12, wherein
the cushioning mechanism comprises an elastic body, which is provided between the second nozzle member and the nozzle holding mechanism that holds the second nozzle member.

14. An exposure apparatus according to claim 1, wherein
a porous body is disposed in the second recovery port.

15. An exposure apparatus according to claim 1, comprising:
a first liquid recovery mechanism that recovers the liquid through the first recovery port of the first nozzle member; and
a second liquid recovery mechanism that recovers the liquid through the second recovery port of the second nozzle member; wherein,
the first liquid recovery mechanism and the second liquid recovery mechanism are driven by separate drive sources.

16. An exposure apparatus according to claim 15, wherein
the drive source that drives the second liquid recovery mechanism comprises an uninterruptible power supply.

17. An exposure apparatus according to claim 1, comprising:
a detector that detects whether the liquid has been collected through the second recovery port; and
a control apparatus that controls the operation of the exposure apparatus based on the detection result of the detector.

18. An exposure apparatus according to claim 17, comprising:
a liquid supply mechanism that supplies the liquid; wherein, the control apparatus controls the operation of the liquid supply mechanism based on the detection result of the detector.

19. A device fabricating method, comprising the step of:
using an exposure apparatus according to claim 1.

20. An exposure apparatus that exposes a substrate by irradiating the substrate with exposure light through a liquid, comprising:
a first member, which is disposed so that it opposes the substrate, that is capable of forming an immersion space between the first member and the substrate; and
a second member, which is provided on the outer side of the first member with respect to the optical path of the exposure light so that it opposes the substrate, that is capable of recovering the liquid on the substrate; wherein,
the distance between the second member and the substrate is less than the distance between the first member and the substrate.

21. An exposure apparatus according to claim 20, further comprising:
a projection optical system that forms an area for the purpose of the exposure; wherein,
the distance between the first member and the substrate and the distance between the second member and the substrate are both in a direction substantially parallel to an optical axis of the projection optical system.

22. An exposure apparatus according to claim 20, wherein
the first member and the second member are separably held.

23. An exposure apparatus according to claim 20, wherein
the first member and the second member are vibrationally isolated.

24. An exposure apparatus according to claim 20, wherein
the first member comprises a first recovery port that recovers the liquid; and
the second member comprises a second recovery port that recovers the liquid.

25. An exposure apparatus according to claim 20, wherein
in at least one of the first member and the second member, a porous body is disposed in the recovery port that recovers the liquid.

26. An exposure apparatus according to claim 20, wherein
the second member is disposed so that it recovers the liquid that was not completely recovered by the first member.

27. An exposure apparatus according to claim 20, further comprising:
a detector that detects whether the liquid has been recovered by the second member.

28. A device fabricating method, comprising the step of:
using an exposure apparatus according to claim 20.

29. An exposure method that exposes a substrate through a liquid, comprising the steps of:
recovering the liquid through a first member; and
recovering the liquid, which was not completely recovered by the first member, via a second member, which is disposed at a position closer to the substrate than the first member.

30. An exposure method according to claim 29, wherein
a first recovery port that recovers the liquid is provided to the first member; and
a second recovery port that recovers the liquid is provided to the second member.

31. A device fabricating method, comprising the step of:
using an exposure method according to claim 29.

32. An exposure apparatus that exposes a substrate by irradiating the substrate with exposure light through a liquid, comprising:
a substrate stage that holds the substrate;
a first member, which is disposed so that it opposes the substrate, that is capable of forming an immersion space between the first member and the substrate; and
a second member, which is provided on the outer side of the first member with respect to an optical path of the exposure light so that it opposes the substrate, that is capable of supplying the liquid onto the substrate; wherein,
the distance between the second member and the substrate stage is less than the distance between the first member and the substrate stage.

33. An exposure apparatus that exposes a substrate by irradiating the substrate with exposure light through a liquid, comprising:
a first recovery port that is capable of recovering the liquid on the substrate; and
a second recovery port, which is provided on the outer side of the first recovery port with respect to an optical path of the exposure light and is separate from the first recovery port, that is capable of recovering the liquid on the substrate; wherein,
the distance between the second recovery port and the substrate is less than the distance between the first recovery port and the substrate.
